(19) United States
(12) Patent Application Publication
(10) Pub. No.: US 2012/0284138 A1
(43) Pub. Date: Nov. 8, 2012

(54) COMPUTERIZED SYSTEM AND METHOD FOR PRESENTING DISCOUNT OFFERS

(76) Inventor: John T. Shave, Chicago, IL (US)

(21) Appl. No.: 13/187,431

(22) Filed: Jul. 20, 2011

Related U.S. Application Data
(60) Provisional application No. 61/481,710, filed on May 2, 2011.

(51) Int. Cl. G06Q 30/08

(52) U.S. Cl. 705/26.3

(57) ABSTRACT

A computer system includes a communications interface configured to communicate with a plurality of users via remotely located user devices. The computer system further includes processing electronics coupled to the communications interface and configured collect bids for at least one of a good, service, and discount from the plurality of user devices. The processing electronics include a bidding module configured to determine winning bids and losing bids by comparing the bids to a floor price. The bidding module is configured to determine whether the losing bids quality for re-bidding by comparing the losing bids to a first merchant-established threshold difference from the floor price.

### CROSS-REFERENCE TO RELATED APPLICATIONS

The present application claims the benefit of U.S. Provisional Application No. 61/481,710, filed May 2, 2011, which is incorporated herein by reference in its entirety.

### BACKGROUND

The present disclosure relates generally to the field of discount offers of goods or services. More specifically, the present disclosure relates to computerized systems and methods for presenting discount offers to users.

Conventionally retailers or service providers market directly to customers via in-store sales, coupons, advertisements, and the like.

### SUMMARY

One embodiment relates to a computer system including a communications interface configured to communicate with a plurality of users via remotely located user devices. The computer system further includes processing electronics coupled to the communications interface and configured to collect bids for at least one of a good, service, and discount from the plurality of user devices. The processing electronics include a bidding module configured to determine a winning group of bids and a losing group of bids. The processing electronics limit any one user to a single bid prior to determining the winning group of bids and losing group of bids.

In some embodiments, the processing electronics may notify the users associated with the winning group of bids and the users associated with the losing group of bids by sending an e-mail. The e-mail may provide a link for the users associated with the losing group. The link may allow the users associated with the losing group to submit another bid for the good, service, or discount. The processing electronics may determine whether to provide the link allowing the other bid based on whether any quantity of the good, service, or discount is remaining. The processing electronics may determine the winning group of bids and the losing group of bids based on the number of bids received from the plurality of users. The processing electronics may use the communications interface to transmit information for allowing the remotely located user devices to enter the bids and to generate graphical user interfaces about the good, service, or discount. The information communicated from the processing electronics may include at least one of: web page information, hypertext information, XML information, and user application information. The processing electronics may cause the communications interface to transmit information to the user devices for rendering at least one graphical user interface for receiving bid information from the user. The processing electronics may cause the at least one graphical user interface to include a user control that allows the user to purchase the good, service, or discount at a non-confidential price and to avoid the bidding process. The processing electronics may cause the winning price threshold to be hidden from the winning group and the losing group. The processing electronics may cause bidding activity from other users to be hidden from any particular user. The processing electronics may cause a graphical user interface shown on a user device to display social networking options. The social networking options may include sharing information regarding the good, service, or discount via a social networking system.

Another embodiment relates to a computerized method for providing a good, a service, or a discount to a user. The computerized method includes using communications electronics to provide a plurality of user interfaces with information about the good, service, or discount. The computerized method further includes receiving, using the communications electronics, bids for the good, service, or discount from a plurality of user devices. The computerized method also includes using processing electronics coupled to the communications electronics to collect the received bids and to determine a winning group of bids and a losing group of bids. The computerized method also includes limiting any one user to a single bid prior to determining the winning group of bids and the losing group of bids. In some embodiments, the computerized method may include hiding the bidding activity from other users from any particular user. The computerized method may include notifying users associated with the winning group of bids and users associated with the losing group of bids. The computerized method may include using the processing electronics to determine the winning group of bids and the losing group of bids based on the number of received bids. The computerized method may include, for determining the winning group of bids and losing group of bids based on the number of bids: closing a bidding session within which the received bids are collected, counting the collected bids, dividing the number of collected bids by a number of bid groups to obtain a bid number per bid group, assigning a price per bid group, filling the bid groups with bids based on the submission order, and determining whether the bids within each group are winning bids or losing bids by comparing each bid with the bid's bid group price. The first bids received by the system may be assigned to the bid group with the lowest price and the last bids received by the system may be assigned to the bid group with the highest price. Assigning a price per bid group may include receiving inputs from a merchant module configured to receive user inputs from a merchant regarding pricing parameters.

Another embodiment relates to non-transitory computer usable medium comprising computer readable program code embedded therein, said computer readable program code adapted to be executed to: (a) use communications electronics to provide a plurality of user interfaces with information about the goods, services, or discounts, (b) receive, using the communications electronics, bids for the good, service, or discount from a plurality of user devices, (c) use processing electronics coupled to the communications electronics to collect the received bids and to determine a winning group of bids and a losing group of bids, and (d) limit any one user to a single bid prior to determining the winning group of bids and the losing group of bids. The computer readable program code may further be adapted to be executed to hide the bidding activity from other users from any particular user. The computer readable program code may further be adapted to be executed to use the communications electronics to notify users associated with the winning group of bids and users associated with the losing group of bids. The computer readable program code may further be adapted to be executed to use the processing electronics to determine the winning group of bids and the losing group of bids based on the number of received bids.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a computerized system for presenting discount offers (i.e., a bidding system), according to an exemplary embodiment;

FIG. 2A is a flow chart of a process for the computerized system providing offers to a user for purchasing and bidding, according to an exemplary embodiment;

FIG. 2B is a flow chart of a process for the computerized system providing offers to a user for purchasing and bidding, according to another exemplary embodiment;

FIGS. 3A-F are flow charts of sub-processes of the processes of FIG. 2A-B describing various functions of the computerized system, according to an exemplary embodiment;

FIGS. 4-7 are illustrations of a graphical user interface for the computerized system of FIG. 1, according to an exemplary embodiment;

FIGS. 8A-B are flow charts of processes for determining winning and losing bids, according to an exemplary embodiment;

FIG. 9 is a flow chart of a process for a computerized system allowing a user to buy an offer selected from a list of available offers, according to an exemplary embodiment;

FIGS. 10-21 are illustrations of graphical user interfaces for the computerized system and the process of FIG. 9, according to an exemplary embodiment;

FIGS. 22-28 are illustrations of graphical user interfaces for the computerized system and the process of FIG. 9, according to another exemplary embodiment;

FIG. 29 is a flow chart of a process for providing merchant access to the computerized system, according to an exemplary embodiment; and

FIGS. 30A-D are flow charts of processes for redeeming offer vouchers, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a computerized system and method for presenting discount offers (e.g., a bidding system) is disclosed which allows a user to find, bid on, and/or buy offers via the computerized system. The computerized system is further configured to determine a winning group of bids and losing group of bids based on all bids received. The computerized system may further be configured to limit a user to a single bid before determining a winning group of bids and losing group of bids.

Types of offers or products that may be purchased or bid on by a user using the computerized system may include, for example, movie tickets, sporting tickets, restaurant discounts, spa gift cards, retail store discounts or gift cards, service discounts or gift cards, etc. In an exemplary embodiment, the computerized system tracks prior user browsing, searching, bidding, or other activities to determine which types of offers or products the user likely prefers. Such preferences may form the basis for the ordering or content of offers presented to any specific user.

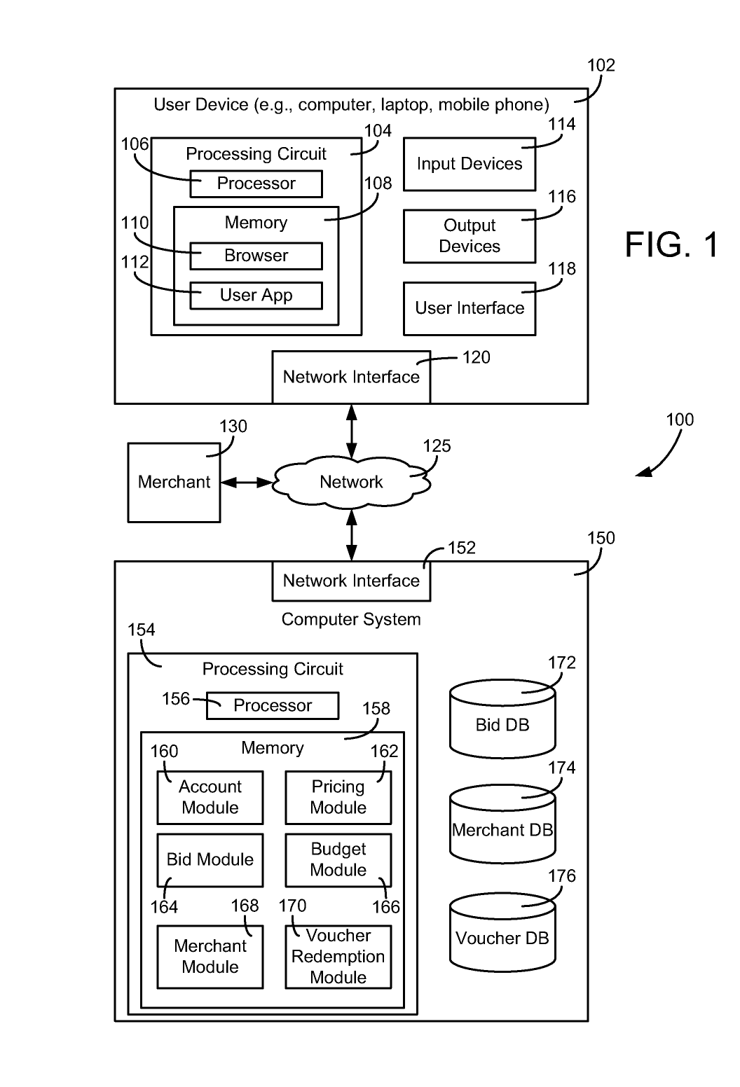

Referring to FIG. 1, a block diagram of a computerized system or bidding system 100 of the present disclosure for presenting discount offers is shown, according to an exemplary embodiment. System 100 for presenting discount offers (e.g., a bidding system) includes a user device 102 (e.g., a computer, laptop, mobile phone, PDA, or other computing device operated by a user) that provides information relating to bids and purchases the user wishes to make on offers made available by system 100 to computer system 150. Computer system 150 further receives offer information from merchants or vendors 130 providing the offers for sale. The offers may include discounts for services being offered by the merchant for the user, products for sale from the merchant, services for sale from the merchant, or other offers.

System 100 includes a user device 102 (e.g., mobile phone, laptop, etc.) for viewing offers and submitting bids and purchase orders. User device 102 includes a processing circuit 104, input and output devices 114 and 116, user interface 118, and network interface 120. Processing circuit 104 generally includes a processor 106 and memory 108 for completing the various user or client processes of the present disclosure. Processor 106 may be implemented as a general purpose processor, an application specific integrated circuit (ASIC), one or more field programmable gate arrays (FPGAs), a group of processing components, or other suitable electronic processing components. Memory 108 is one or more devices (e.g., RAM, ROM, flash memory, hard disk storage, etc.) for storing data and/or computer code for completing and/or facilitating the various user or client processes, layers, and modules described in the present disclosure. Memory 108 may be or include volatile memory or non-volatile memory. Memory 108 may include database components, object code components, script components, or any other type of information structure for supporting the various activities and information structures of the present disclosure. Memory 108 may be communicably connected to processor 106 and includes computer code or instructions for executing one or more processes described herein.

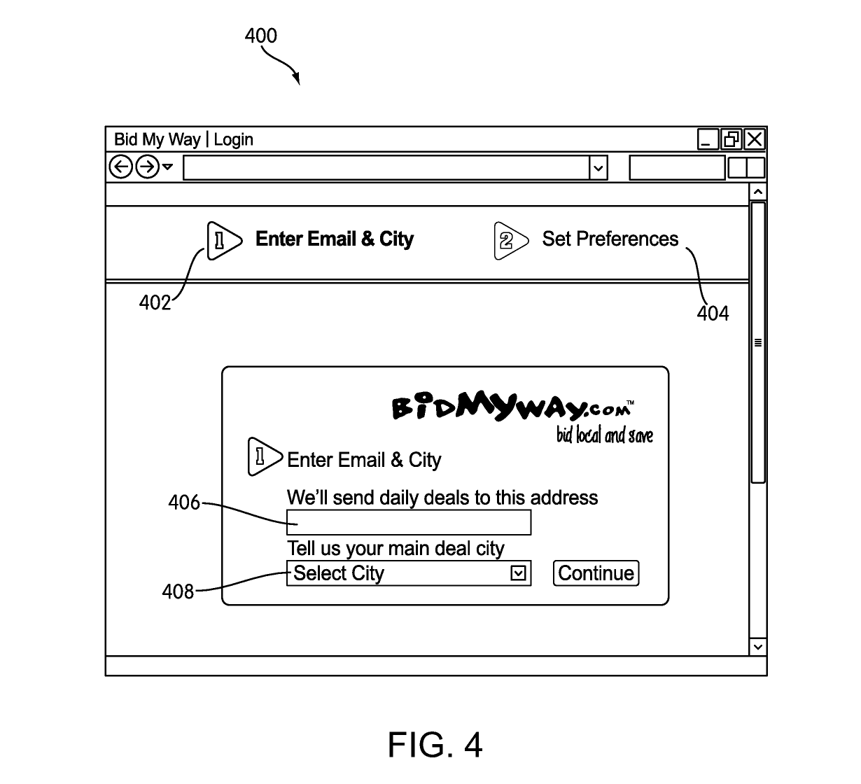

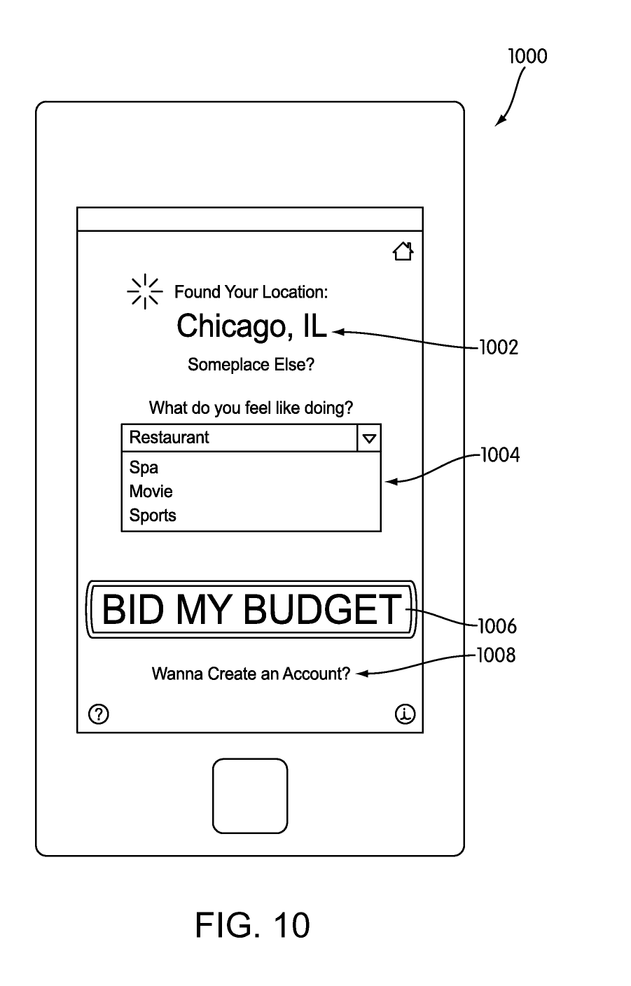

Memory 108 is shown to include a browser module 110 and a user app module 112. Browser module 110 is configured to provide a software application for viewing web-based offers and product information on system 100. Browser module 110 may be used when the user is accessing system 100 on a laptop, desktop, or a mobile device that does not have or support a particular app for interfacing with system 100. User app module 112 is configured to provide an application on, for example, a mobile phone or other handheld device. As examples, the embodiments shown in FIGS. 4-7 are examples of applications provided by browser module 110 and the embodiments shown in FIGS. 10-28 are examples of applications provided by user app module 112. In various exemplary embodiments, elements of the screenshots of FIGS. 4-7 and FIGS. 10-28 may be mixed or shown on either type of client (e.g., a browser-based client or an application-based client).

User device 102 further includes network interface 120 which is configured to communicate with computer system 150 via one or more networks 125 (e.g., a mobile phone network, the Internet, etc.). Input devices 114 may include any input device (e.g, keyboard, mouse, phone keypad, touchscreen, etc.) that may be used by a user of device 102 to submit bids and purchase orders. Output devices 116 may include display screens, monitors, speakers, and/or other visual and audio components for providing a user of device 102 with offers and offer information. User interface 118 can be any control, pointer, keypad, sensor, or sensors configured to accept user input relating to bids and purchase orders for the offers. It should be appreciated that some user devices 102 (e.g., full computers) will include many input devices 114, output devices 116, or user interfaces 118 while other user devices 102 (e.g., a touchscreen-based mobile phone) will primarily have a single touchscreen display for all user input/output activities.

System 100 further includes a computer system 150. Computer system 150 receives offer information from a merchant 130 connected to the computer system via a network 125. Computer system 150 further receives bids and purchase orders from multiple user devices 102 that connect to computer system 150 via network 125.

Computer system 150 includes a processing circuit 154 including a processor 156 and memory 158. Processor 156 may be implemented as a general purpose processor, an application specific integrated circuit (ASIC), one or more field programmable gate arrays (FPGAs), a group of processing components, or other suitable electronic processing components. Memory 158 is one or more devices (e.g., RAM, ROM, Flash memory, hard disk storage, etc.) for storing data and/or computer code for completing and/or facilitating the various user or client processes, layers, and modules described in the present disclosure. Memory 158 may be or include volatile memory or non-volatile memory. Memory 158 may include database components, object code components, script components, or any other type of information structure for supporting the various activities and information structures of the present disclosure. Memory 158 may be communicably connected to processor 156 and includes computer code or instructions for executing one or more processes described herein.

Memory 158 includes various modules for completing the processes described herein. Memory 158 is shown to include account module 160. Account module 160 is configured to receive account information about users of system 100. Account information of the users may include the name of the user, address of the user, phone number or other contact information (e.g., e-mail) of the user, payment information (e.g., credit card information or online account information) of the user, user verification information (e.g., a password associated with the user account), user preference information, or other user information. Using account module 160, system 100 may register or subscribe the user to the system. Account module 160 may further be configured to validate user credentials or user information and help process transactions for system 100. For example, when computer system 150 receives a bid or purchase order from device 102, account information (e.g., password, payment methods, address, etc.) provided with the bid or purchase is verified by account module 160 before computer system 150 processes the bid or purchase order. Account module 160 may further include other user information used by computer system 150 to determine the type of offers to provide to the user, any rewards, discounts or other incentives to provide to the user, or otherwise. For example, account module 160 may include account activity or history information (e.g., date of last login, number of purchases, detail regarding previous purchases, etc.). Such activity or history information may be used to determine whether the user is a frequent bidder or purchaser. Computer system 150 may use such information to provide customized offers, discounts, or rewards to the user.

Memory 158 further includes pricing module 162 which is configured to determine the pricing of various offers provided by system 100. For example, pricing module 162 may set a purchase price for an offer. The purchase price may be provided by merchant 130 or merchant database 174, or pricing module 162 may automatically calculate or alter the purchase price provided by merchant 130 based on factors such as date and quantity. For example, pricing module 162 may automatically calculate or alter a purchase price of an offer depending upon the quantity of the offer that is available. As another example, pricing module 162 may automatically calculate or alter a purchase price of an offer that has a specific date or time associated with the offer. For example, for sporting events or concerts, pricing module 162 may lower the price of the tickets as the date of the event draws near, in order to sell the tickets. Pricing module 162 may make such alterations to the price via a merchant-set strategy (e.g., merchant 130 specifies a specific date or time at which the price for the offer should be raised or reduced).

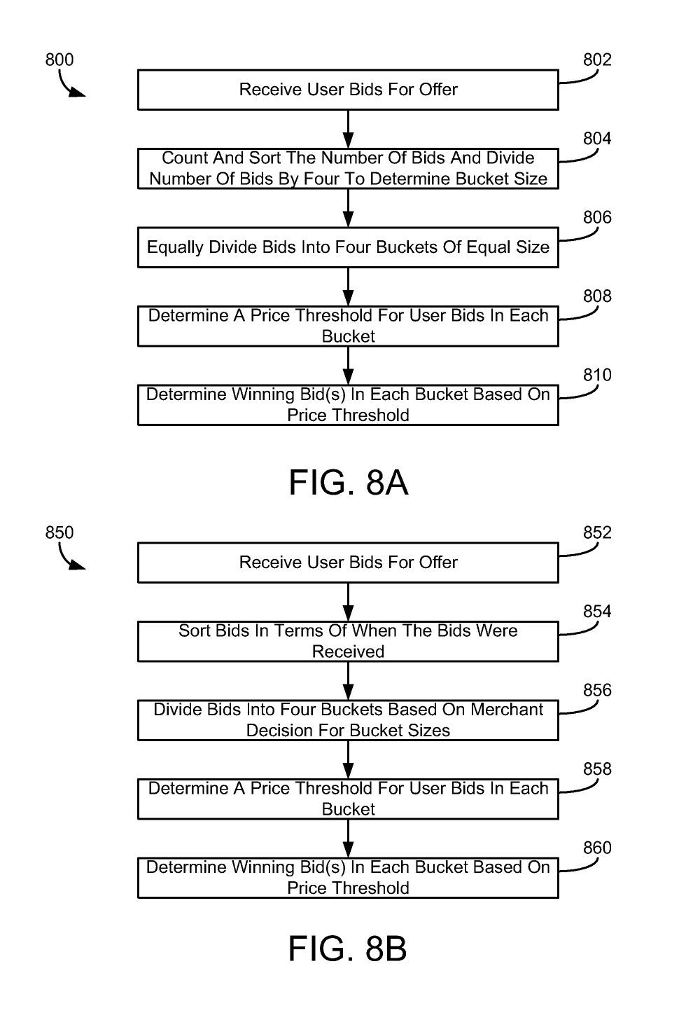

Pricing module 162 may determine a minimum price for which a bid for an offer is to be accepted. For example, if a user submits a bid for an offer, pricing module 162 may compare the bid to a minimum price threshold set by pricing module 162. After the comparison, computer system 150 may determine whether to accept or reject the bid, whether to offer the user a second chance to bid on the offer, or whether to take another action in response to the received bid. According to one exemplary embodiment, pricing module 162 may include more than one minimum price threshold for an offer (e.g., a bid that is submitted from a first set of users before a sales threshold is reached may be compared with a lower minimum price threshold relative to bids submitted after the sales threshold is exceeded). The flow charts of FIGS. 8A-B (and accompanying text) describe exemplary processes 800, 850 for using various minimum price thresholds to determine winning bids. The thresholds set by pricing module 162 may be used by system 100 to determine a winning group of bids and a losing group of bids for a collection of bids received by computer system 150.

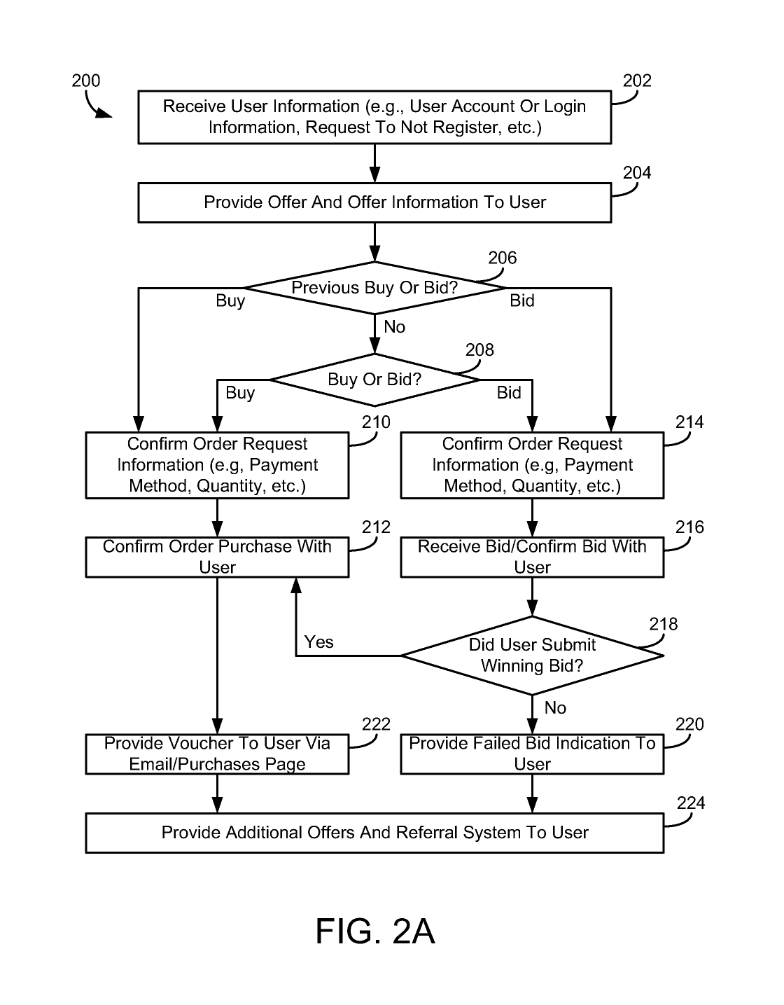

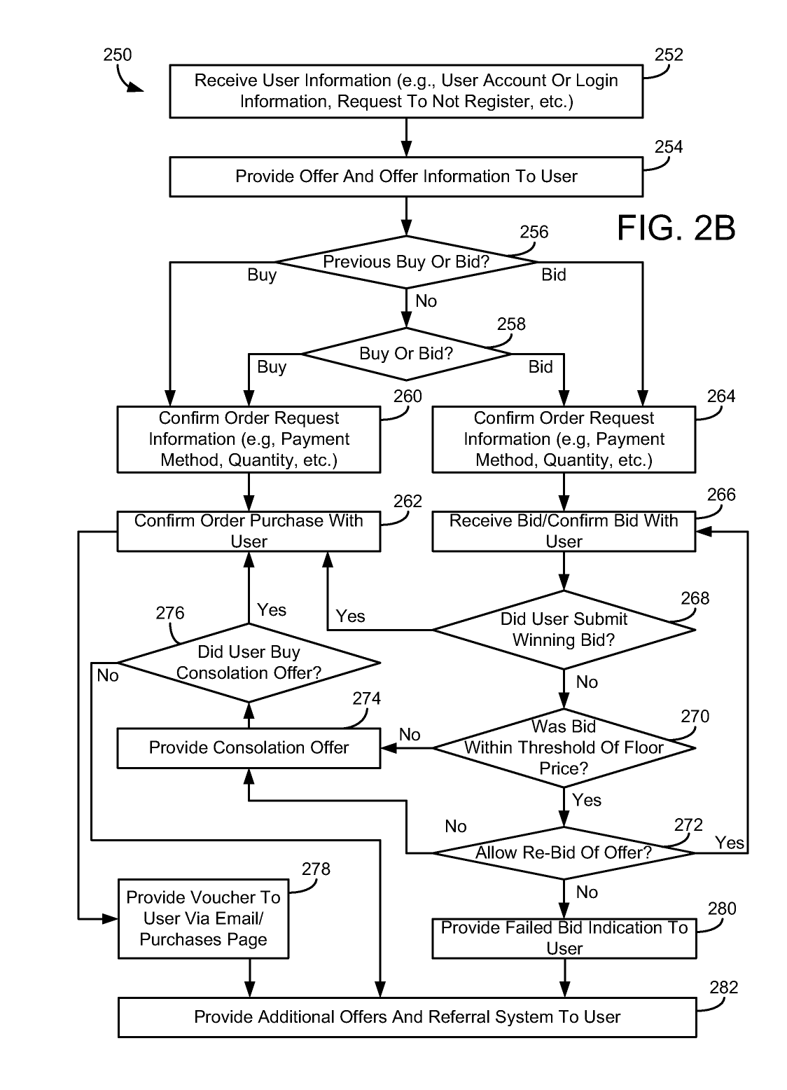

Memory 158 further includes a bid module 164 and budget module 166. Bid module 164 is configured to provide (via a browser or user app on the user device 102) user interfaces for allowing users to bid on and purchase offers. For example, bid module 164 is configured to provide, via browser 110 or user app 112, an offer to the user and the ability for the user to either bid on or purchase the offer. Based on user input received at the user device 102 and provided to computer system 150 via network interfaces 120, 152 and network 125, bid module 164 determines whether a user bid is accepted or denied. Bid module 164 can operate in concert with pricing module 162 to determine whether the input bid matches updated pricing conditions set by pricing module 162. Bid module 164 may store bids from multiple users in a bid database 172, and may, after a designated period of time, retrieve bids from bid database 172 to select one or more winning bids. Bid module 164 may further determine if a user has bid on a specific offer and may limit the user from bidding on the offer a second time until an initial group of winning bids and losing bids are determined by system 150. The activities of bid module 164 is described in greater detail in the processes of FIGS. 2A-B.

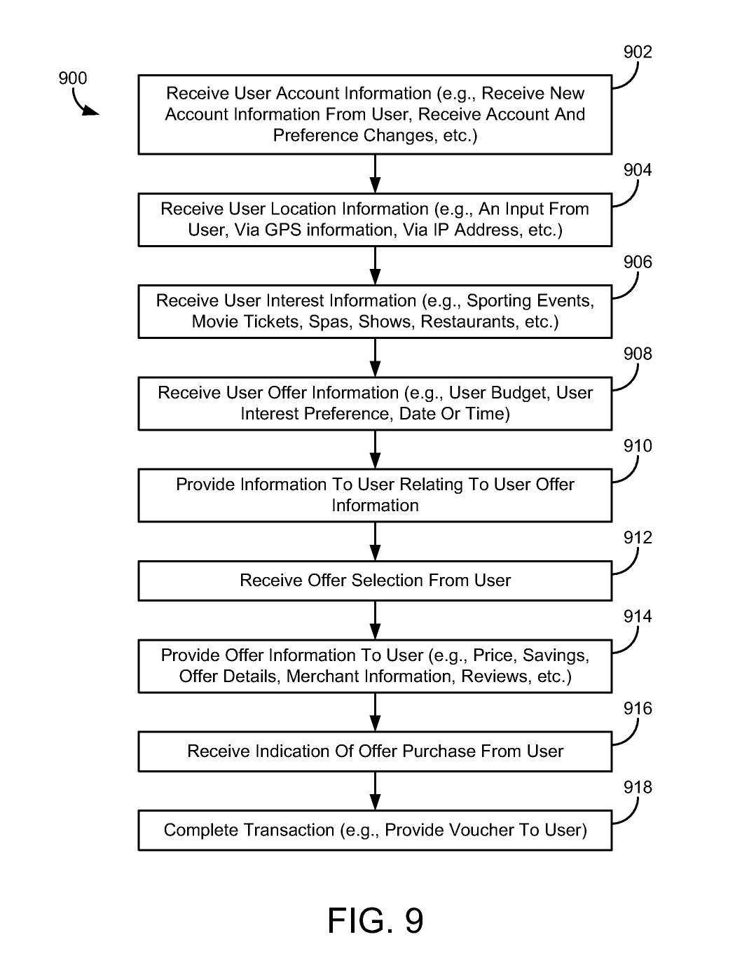

Budget module 166 is configured to allow users to specify a budget and to provide offers to a user based on the specified budget and other parameters (e.g., type of offer, date and time, etc.). Budget module 166 determines the most appropriate offers for a user based on received user information and received user budget information and other parameters. The activities of budget module 166 is described in greater detail with reference to FIG. 9.

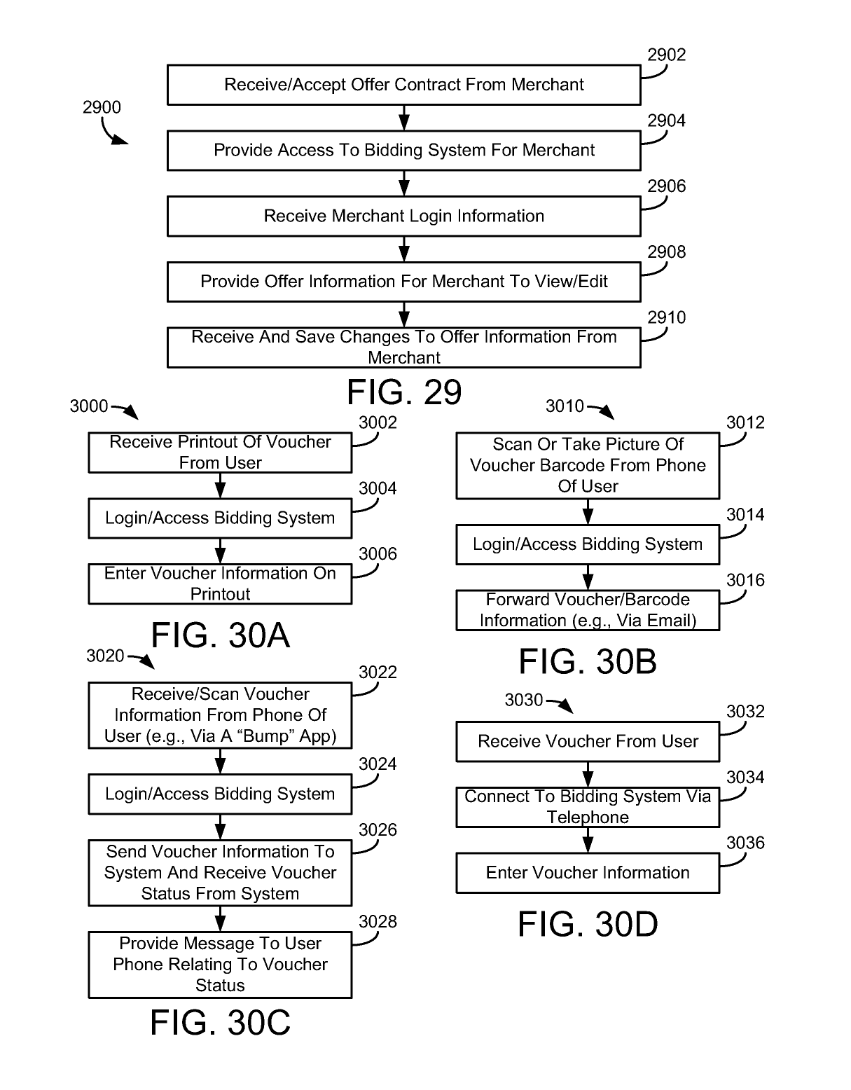

Memory 158 further includes a merchant module 168. Merchant module 168 is configured to allow a merchant 130 providing the various offers and products for system 100 access to system 100. Such access may be provided via web services, merchant client applications, or other computerized interfaces with a merchant device. Merchants 130 may provide the offer details (e.g., time and date of the offers, products or services included in the offer, quantity of the offer available, pricing information, etc.) to system 100. Merchants 130 may additionally edit offer information via an interface provided (e.g., served) by merchant module 168. Computer system 150 may then store offer information in merchant database 174. Merchant module 168 is described in greater detail with reference to FIG. 29.

Memory 158 further includes a voucher redemption module 170. Vouchers may be used to redeem a purchased offer. For example, if tickets for an event are purchased, computer system 150 provides the user purchasing the tickets with a voucher (e.g., via mail, e-mail, other message, etc.) that may be used to redeem the offer. Computer system 150 may provide the voucher using voucher redemption module 170. Voucher redemption module 170 is additionally configured to receive voucher information from user device 102 and/or merchant 130 and allows the voucher to be redeemed by the user or merchant. For example, voucher redemption module 170 may receive voucher information and validate the use of the voucher to obtain the service or product provided by the offer. Voucher redemption module 170 may store voucher information (e.g., voucher information for vouchers provided to users, voucher information for un-redeemed vouchers, etc.) in a voucher database 176. Voucher redemption is described in greater detail with reference to FIGS. 30A-D.

Bid database 172 may store all user bid information (e.g., the users submitting the bids, the bid value, the timestamps of the bids, quantity information, etc.). Merchant database 174 may store all merchant and offer information (e.g., merchants using system 100, all offers provided by the merchants, offer information or parameters such as price, date and time, types of products and services offered, etc). Voucher database 176 may store all voucher related information (e.g., voucher information for redeemed or un-redeemed offers).

Referring generally to FIGS. 2-8, systems and methods for presenting discount offers to a user are shown, according to one exemplary embodiment. The systems and methods of FIGS. 2-8 allow a user to bid on or purchase offers via the bidding system of FIG. 1. In some embodiments, for example, the user has a choice of purchasing an offer at a given price or entering a bid for the offer at a lesser price. If the user enters a bid at the lesser price, the bid may be accepted or rejected by the bidding system. The bid may be accepted or rejected based on one or more predetermined or calculated thresholds or reserves. In some embodiments, a bid may compete with other received bids, and one or more bids may be selected by the bidding system (e.g., once a day's worth of bids have been collected) for the winning group of bids and one or more bids may be selected as the losing group of bids.

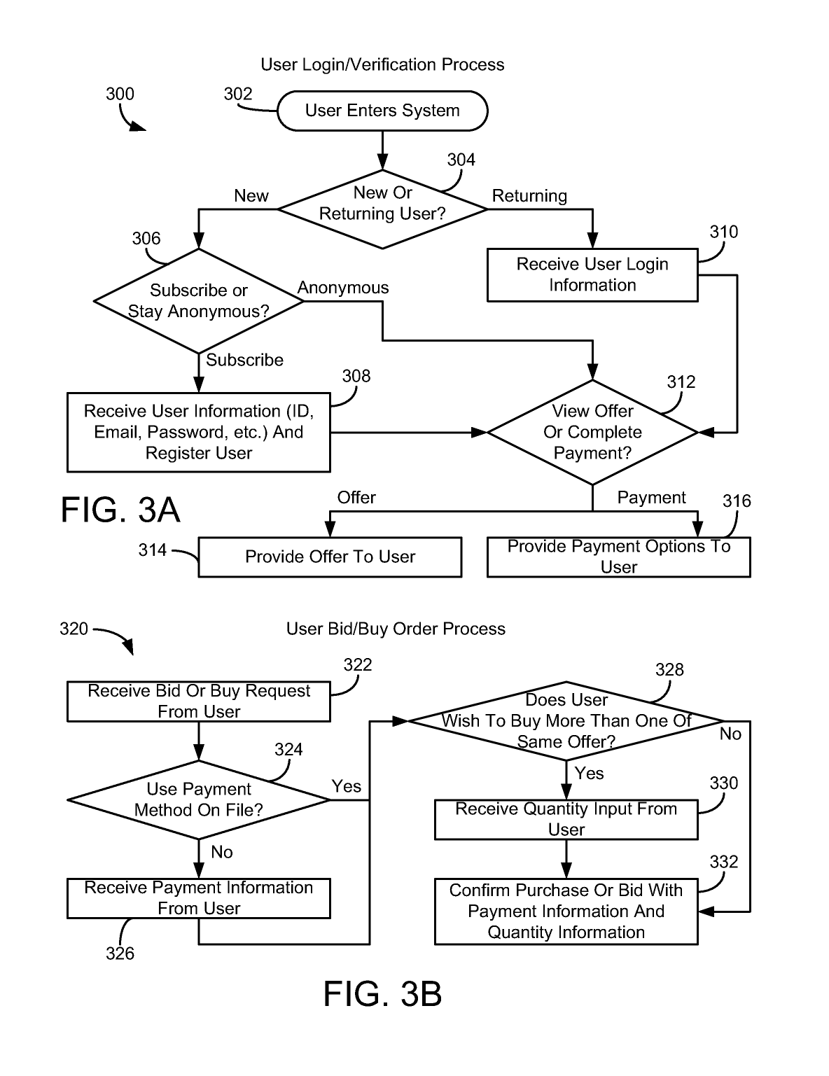

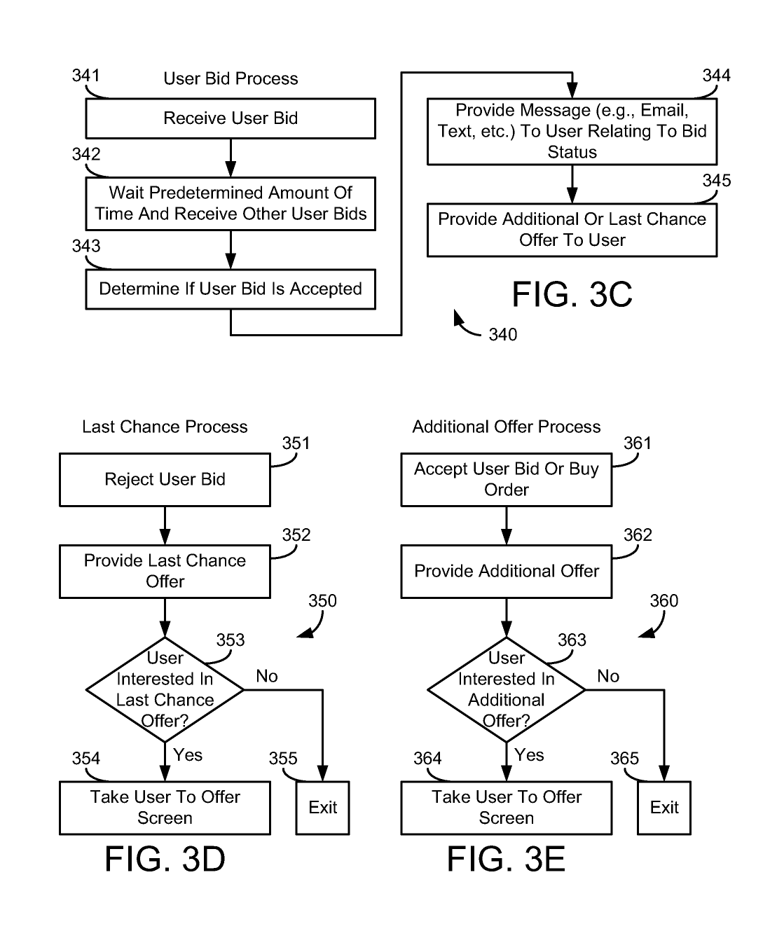

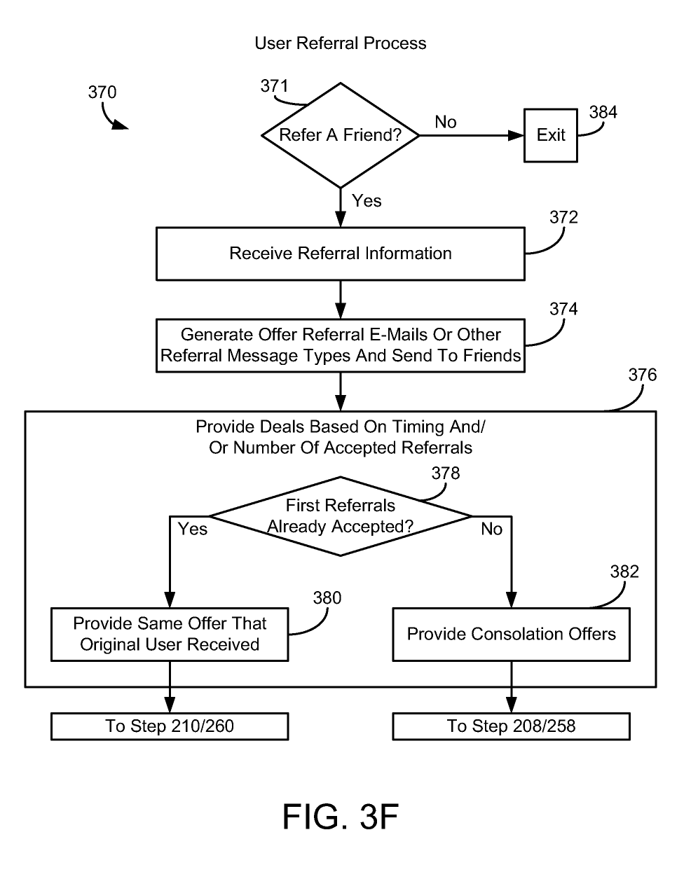

Referring now to FIG. 2A, a flow chart of a process 200 for allowing a user to bid on or purchase an offer is shown, according to an exemplary embodiment. Process 200 may generally allow a user to buy or bid on an offer and provide the offer to the user if the user purchased the offer or won the bid. Process 200 includes limiting a user to a single bid prior to determining a winning group of bids and losing group of bids; according to various exemplary embodiments, process 200 may allow multiple bids or other methods for the user to buy or bid on an offer. Process 200 includes receiving user information (step 202). User information may include user account information and login information for the user (e.g., to allow the user to access the bidding system), as well as any additional information used for user verification. Step 202 may further include receiving an indication from the user not to register or login to the bidding system (e.g., to view the user interfaces provided by the bidding system via a guest or anonymous login). Step 202 is shown in greater detail in FIG. 3A.

Process 200 further includes providing offers and offer information to the user (step 204). The offer and offer information may be retrieved from a database (e.g., merchant database 174) of the bidding system, formatted, and provided to a user device of the user. Offer information may include the price of the offer, a description of the products and services provided in the offer, information about the merchant providing the offer, graphics relating to the offer, or other information. Providing the offers and offer information to the user can include providing web-pages, web-content, XML content, application content, or other data from a server computer (e.g., computer system 150) to a user's client device (e.g., user device 102).

Process 200 further includes determining whether the user had a previous bid or buy decision on the offer (step 206). For example, if the user, in a previous session in the bidding system, had indicated a desire to buy or bid on the offer, the bidding system allows the user to complete a bid or buy transaction if it was not completed in the previous session. Step 206 may further include other options relating to a previous session (e.g., providing a discount offer based on a previous rejected or accepted bid from the previous session, alerting the user to bid statuses, etc.). Process 200 further includes receiving an indication from the user indicating a preference to bid on or buy the offer (step 208). The user may choose to either purchase the offer at a given price or bid on the offer at a lesser price. If the user chooses to buy the offer, process 200 includes confirming the order request and order request information (step 210). Order request information may include a payment method the user wishes to use for the offer, the quantity of offer being purchased, customizable offer options, payment information, delivery information, or other information. Process 200 further includes confirming the order purchase (step 212).

If the user chooses to bid on the offer, the user provides a bid (e.g., a price at which the user is willing to purchase the offer at). The bid may be provided with information such as price, quantity, an offer identifier, or other bid information from the user device to the server computer system. Process 200 includes confirming the order request and order request information (step 214) and receiving and confirming the bid with the user (step 216). Steps 208-216 are shown in greater detail in FIG. 3B.

If the user submitted a winning bid (step 218, described in greater detail with reference to FIG. 3C and FIGS. 8A-B), the order purchase at the price of the winning bid is confirmed with the user (step 212). If the user did not submit a winning bid, an indication (e.g., e-mail, text, or other message) that the user did not submit a winning bid is provided to the user (step 220). If the user completed a purchase associated with a winning bid or other purchase, a voucher is provided to the user (step 222) that may be used to redeem the offer. The voucher may be provided via email. The voucher may further be viewed by the user on a purchases webpage provided by the bidding system or via another user interface. Process 200 further includes providing additional offers and a referral system to the user (step 224). Step 224 may further include a user feedback option, an option for the user to access another offer, or an option for the user to take other actions. Step 224 is shown in greater detail in FIGS. 3D-F. Steps 222-224 may further include providing a “thank you” screen, an account summary screen, or a verification screen to the user (e.g., so that the user may verify the purchase of the offer).

Referring now to FIG. 2B, a flow chart of a process 250 for allowing a user to bid on or purchase an offer is shown, according to another exemplary embodiment. While process 200 of FIG. 2A describes a process where only one bid is allowed, process 250 of FIG. 2B shows another exemplary embodiment where multiple bids and consolation offers may be provided to the user instead of a single bid. For example, if a bid is a losing bid, the bid may be compared to a floor price, and another bidding attempt may be provided to the user if the losing bid is within a merchant-established threshold difference from the floor price.

Process 250 includes receiving user information (step 252) and providing offers and offer information to the user (step 254). Process 250 further includes determining whether there was a previous buy or bid offer from the user (step 256) and receiving an indication if the user wants to buy or bid on an offer (step 258). If the user wants to buy an offer, order request information is confirmed (step 260) and the purchase is confirmed with the user (step 262). If the user wants to bid on an offer, order request information is confirmed (step 264) and the bid is received and confirmed with the user (step 266). Steps 252-266 may be similar to steps 202-216 of process 200.

Process 250 further includes determining if the user submitted a winning bid (step 268, described in greater detail with reference to FIG. 3C and FIGS. 8A-B). In one embodiment, step 268 includes determining if a bid was below or above a floor price (e.g., a minimum price for which the offer is to be sold). If the user did submit a winning bid, then the order purchase is confirmed (step 262), a voucher is provided to the user (step 278), and addition offers and a referral system are provided to the user (step 282).

If the user did not submit a winning bid (step 268), process 250 may include providing additional bids and/or offers to the user depending on the losing bid. Process 250 further includes determining if the bid was within a threshold of the floor price of the offer (step 270). The floor price may be set by a merchant, set by the bidding system, or may be calculated by the bidding system or merchant based on the full value of the offer. The threshold may be established by a merchant, according to an exemplary embodiment. The threshold may be a percentage (e.g., the threshold may be set as 80% or 90% of the floor price), a number of bids (e.g., the bidding system allows the user to bid multiple times until all allowed bids are exhausted), or a specific cost (e.g., $20, $30, etc.).

More than one threshold may be used by step 270. For example, a merchant may set two threshold values where a second threshold is closer to the floor price than a first threshold. In one embodiment, if a losing bid is above the first threshold but below the second threshold, the user may receive fewer re-bids than if the losing bid was above both thresholds. In another embodiment, if a losing bid is above the first threshold but below the second threshold, the user may not be eligible for the same offer or may not be allowed to re-bid on the offer, while losing bids above both thresholds may be allowed to re-bid. The thresholds and floor price information may be hidden from the winning bidders and losing bidders, according to an exemplary embodiment.

Referring further to step 270, the merchant may be provided an input tool for allowing the merchant to set a floor price or thresholds of the offer. The merchant may connect to the bidding system remotely via a graphical user interface. The merchant may set the floor price and/or thresholds before providing the offer or may change the floor price or thresholds while the offer is being made available (e.g., changing the floor price or threshold based on current offer trends). Merchant activity is described in greater detail in FIG. 29.

If the bid was within the threshold, process 250 may further determine if a re-bid on the offer should be allowed (step 272). The determination may be based on how many times the user has already bid or re-bid on the offer and how close the losing bid was to the floor price (e.g., by comparing the bid to the multiple thresholds as described in step 270). For example, the bidding system may set a limit of number of bids for an offer that the user cannot exceed, regardless of whether the bid was within the threshold or not. If the user has not reached the bid limit (e.g., three re-bids, two re-bids, etc.), the user may provide another bid, and the bidding system receives the bid and confirms the bid (step 266).

If the bid was not within the threshold, if the user has exceeded the number of allowable bids, or if the user is otherwise not allowed to re-bid, then a consolation offer may be provided (step 274), and the failed bid indication is provided to the user (step 280). The consolation offer may be similar or related to the original offer (e.g., tickets for an event in the area that are less expensive, coupons or offers that provide less of a discount than was possible via bidding, a ‘buy it now’ offer that provides less of a discount than was available via correct bidding, etc.). Process 250 includes receiving an indication of whether the user wants to buy the consolation offer or not (step 276). If so, the order is confirmed (step 262). If not, additional offers and a referral system is provided to the user (step 282).

Process 250 may include notifying users of winning bids, losing bids, and other offer information via instant graphical user interface feedback provided on the user device. For example, the user may be notified instantly whether a bid was a winning bid or a losing bid. In one embodiment, the bidding system provides such notifications prior to receiving all of the bids for a particular offer; in other embodiments, the bidding system may wait to receive all bids or reach a threshold of a number of bids before notifying users.

Processes 200, 250 may include the communicating offer information in various formats. For example, information communicated from the processing electronics (e.g., processing circuit 154 of FIG. 1) of the bidding system may include webpage information, hypertext information, XML information, and user application information. Further, the processing electronics may transmit information for rendering one or more graphical user interfaces for receiving bid information from the user. The graphical user interface may allow the user to purchase the offer at a non-confidential price instead of allowing the user to bid on the offer. Such graphical user interfaces are shown in greater detail in FIGS. 4-7 and FIGS. 10-28.

The bidding activity of other users in processes 200, 250 may be hidden from any particular user. The processing electronics may be configured to display social networking options on the graphical user interfaces. The social networking options may include sharing information regarding the offer via a social network system, sharing a winning bid with a social networking contact, or allowing the social networking contact to purchase the offer as a shared winning bid.

Referring now to FIG. 3A, a user login and verification process 300 is shown, according to an exemplary embodiment. In an exemplary embodiment, step 202 of FIG. 2A or step 252 of FIG. 2B includes or encompass the detailed steps of process 300. The user accesses the bidding system (step 302), and the bidding system receives an indication of whether the user is a new user or returning user (step 304). Step 302 includes the user accessing the bidding system (e.g., viewing an offer or bid prompt) by visiting a website, using a client application, via an e-mail, or otherwise (e.g., via a shared link, via a message on a social networking site like Facebook or Twitter). Step 304 includes receiving a user indication of whether he or she is a new user (e.g., an unregistered potential subscriber of the bidding system) or a returning user (e.g., a registered subscriber with information stored in account module 160 of the bidding system). Step 304 may include receiving the user indication via a website or social networking site. For example, if the user connected to the bidding system via a Facebook link or other social networking site, then the social networking site may provide initial user information to the bidding system for the user.

If the user is a new user, an option is given to the user to either subscribe or stay anonymous (e.g., not subscribe) (step 306). If the user wishes to remain anonymous, the bidding system may be configured not to allow the user to bid on or purchase offers, but may allow the user to view the offers (step 312). In other embodiments, the user may bid on offers, but is required to register to determine whether the bid is winning or to collect a voucher associated with a winning bid. If the anonymous user eventually wishes to bid on or purchase an offer, the user may be redirected to step 308 of process 300. If the user wishes to register, the bidding system may receive user information to store in account module 160 (step 308). User information may include a user ID, e-mail, address or location, password to access the account, etc. If the user is a returning user, the bidding system receives user login information for the user (step 310), either from the user or via a website or social networking site the user is using to connect to the bidding system.

Once the user logs in or is otherwise verified by process 300, at step 312, the user may choose to view an offer or to complete a payment on a previous offer or bid (e.g., an offer or bid made while the user was operating as anonymous). At a step 314, the bidding system selects a new offer and provides the offer to the user. At a step 316, the bidding system provides payment options to the user relating to a previously selected offer. Steps 314, 316 may return a user to user interfaces associated with step 204 of FIG. 2A or step 254 of FIG. 2B.

Referring now to FIG. 3B, a process 320 for confirming a bid or buy on an offer is shown, according to an exemplary embodiment. Process 320 may provide a detailed version of, e.g., steps 208-216 or steps 258-266 shown and described with reference to FIGS. 2A-B. Process 320 includes receiving a bid or buy request from the user (step 322). The request may be received via webpage of the bidding system, a client application, or at another interface of a server computing system (e.g., system 150 shown in FIG. 1). The user may either enter a value of a bid for an offer, select a value via a user interface control, or select a button indicating a desire to purchase the offer.

Once the request is received from the user, process 320 includes asking the user whether he or she wishes to use the payment method on file (step 324). For example, the user may choose to use the payment method on file (e.g., stored in account module 160) or provide a new payment method for the bid or buy request. If the user wishes to use a new payment method, process 320 includes receiving the new payment information (step 326).

Process 320 further includes asking the user whether he or she would like to buy or bid on more than one of the same offer (step 328). For example, the user may want to bid on or buy multiple tickets. If so, process 320 includes receiving a quantity input from the user (step 328) and adjusting the bid or buy amount appropriately. Process 320 further includes confirming the bid or buy order from the user (step 330). Step 330 includes verifying the payment information and quantity information.

Referring now to FIG. 3C, a bidding process 340 is shown, according to an exemplary embodiment. Process 340 may be used to determine whether a received bid is a winning bid or a losing bid (e.g., in step 218 of FIG. 2A or step 268 of FIG. 2B). Process 340 includes receiving the user bid (step 341) and storing the bid information. Process 340 waits a predetermined amount of time and receives all user bids during the waited period of time (step 342). After the predetermined time expires, process 340 determines whether each user bid is accepted or rejected (step 343). Step 343 may include, for example, grouping all bids from all users and determining a group of winning bids and a group of losing bids. Process 340 further includes providing a message (e.g., email, web page notification, application notification, text message, etc.) to the user of the bid status for the user (step 344). Process 340 then provides additional or last chance offers to the user (step 345). Exemplary embodiments of bidding process 340 is shown in greater detail with reference to FIGS. 8A-B.

Referring to FIGS. 3D-E, a last chance process 350 and additional offer process 360 (e.g., relating to step 224 of FIG. 2A, step 282 of FIG. 2B and/or step 345 of FIG. 3C) are shown in greater detail, according to an exemplary embodiment. A last chance offer may be provided to a user if the user's bid was rejected, and an additional offer may be provided to a user if the user's bid was accepted. The last chance offer may be an offer related to the offer the user attempted to bid on, offering the user another chance to bid on a lost bid. The additional offer may be of higher value, lower value, or supplement the offer the user successfully bid on.

Last chance process 350 includes rejecting the original user bid (step 351) and providing the related last chance offer (step 352). Process 350 further includes receiving an indication if the user is interested in the last chance offer (step 353). If so, the user may be taken to an offer screen for the last chance offer (step 354) to allow the user to bid on or buy the offer. If not, the user may exit the bidding system (step 355).

Additional offer process 360 includes accepting the original user bid or buy order (step 361) and providing the additional offer (step 362). Process 360 further includes receiving an indication if the user is interested in the additional offer (step 363). If so, the user may be taken to an offer screen for the additional offer (step 364) to allow the user to bid on or buy the offer. If not, the user may exit the bidding system (step 365).

Referring to FIG. 3F, a user referral process 370 (e.g., relating to step 224 of FIG. 2A or step 282 of FIG. 2B) is shown, according to an exemplary embodiment. Process 370 may be used by a bidding system to refer a friend, family member, or acquaintance of the user to the bidding system and to provide offers to the friend. Process 370 includes asking the user of the bidding system whether he or she wishes to refer a friend to the system (step 371). If not, the user may exit the process (step 384). If the user wishes to refer a friend, referral information is provided to the bidding system (step 372). Referral information may include an e-mail of the friend, a phone number, address, or other information of the friend, and links to websites or social networking sites the friend uses (e.g., Facebook, Twitter, etc.). Process 370 includes generating the offer referral e-mails or other referral message types (e.g, Facebook posts, text messages, etc.) and sending the messages to the referred friends (step 374). The messages may relate to the offer that the user has purchased, an offer specified by a user to provide to the friend, or any other offer. For example, the same offer the user just bid on or bought may be provided to the friend at the price the user bid on or bought the offer, or may be provided at a discount price. The user referral system may be configured to provide an indication to the user that upon referring a friend, the friend will be provided with the same offer associated with the user purchase. The offers may be limited to a maximum number of referrals/friends, according to an exemplary embodiment.

User referral process 370 further includes receiving a response from referred friends. Process 370 includes providing deals based on the timing of and/or the number of accepted referrals as a result of the referral process (step 376). For example, step 376 includes receiving a response from a referred friend and determining if the response is related to a specific offer. As another example, step 376 includes determining if the offer provided in the referral is still valid.

Process 370 further includes determining if the first referrals for a given referral have already been accepted (step 378). For example, a user may have referred multiple friends, and step 378 includes determining if other friends have already bought or redeemed an offer. As another example, the first ten users to refer a friend in a given time frame or the first ten friends to be referred may receive a special offer, and step 378 determines if a user or friend qualified for the special offer. Step 378 further includes, if other friends did already buy or redeem an offer, determining if an offer provided to the current friend is still valid, or if the offer is invalid (e.g., because the quantity of the offer has run out). Step 378 may further include any additional step for determining if the offer the friend is responding to is still available or if the offer needs to be rescinded. For example, if the offer has expired, the offer may need to be rescinded.

If the offer is still available, then the same offer that the original user received is provided to the friend (step 380). The friend may then indicate if he/she wants to buy or bid on the offer, and may go through the same process that the original user did (e.g., from step 210 of FIG. 2A or step 260 of FIG. 2B). If the offer is not available, a consolation offer is provided (step 382). The friend may then indicate if he/she wants to buy or bid on the consolation offer, and may go through the same process that the original user did (e.g., from step 208 of FIG. 2A or step 258 of FIG. 2B).

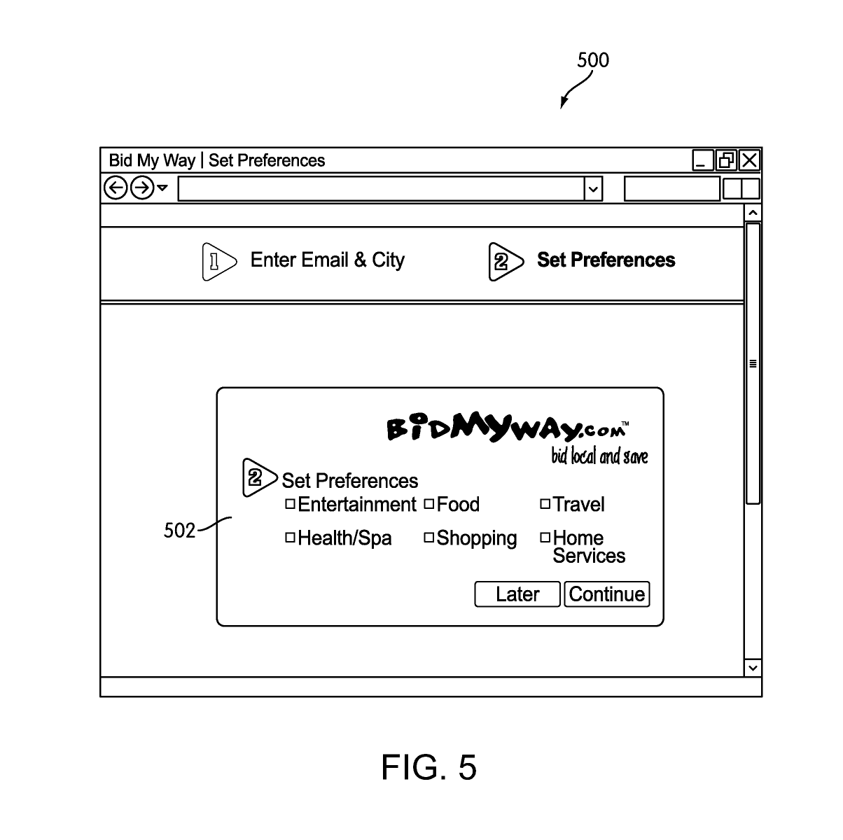

Referring generally to FIGS. 4-7, illustrations of user interfaces that may be provided by the bidding system to complete the processes of FIGS. 2-3 are shown, according to an exemplary embodiment. Referring to FIGS. 4-5, example user interfaces 400, 500 are shown that allow a user to login or subscribe to the bidding system (e.g., via process 300 of FIG. 3A). User interface 400 is an example registration screen that allows the user to register via an e-mail address. For example, upon providing the e-mail address, the user may receive an e-mail from the bidding system for verifying the e-mail address or requesting that the user provide additional subscription or preference information.

Using user interface 400, the user may select whether to view a screen to enter e-mail and location information (using button 402) or a screen to enter user preferences (using button 404). The user may enter his/her e-mail address using text box 406 and specify a location (e.g., state, city, etc.) via drop-down box 408. User interface 400 may further include other boxes or fields to accept additional user information (e.g., the user interface may further include a form to submit a phone number, billing address, credit card information, and other optional user preferences). User interface 500 is an example preference screen that allows the user to select the type of offers he or she would like to receive. For example, in user interface 500, the user may select to view entertainment offers, food offers, travel offers, etc. via checkboxes 502.

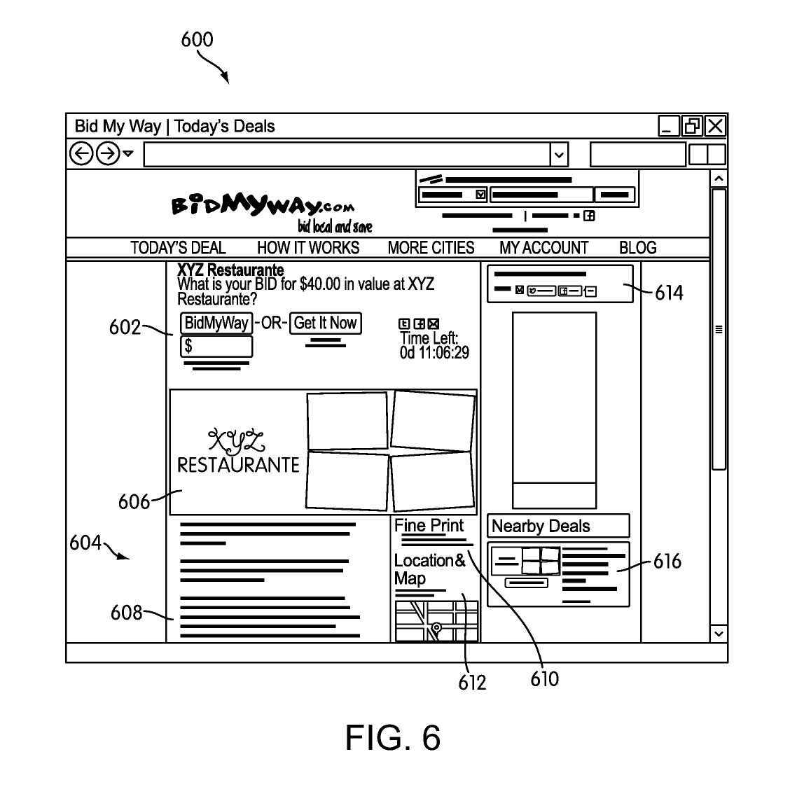

Upon subscribing or logging in using user interfaces 400, 500, or other user interfaces, the bidding system provides the user with a graphical user interface 600 shown in FIG. 6. User interface 600 displays an offer to the user. User interface 600 includes a bid/buy control or form 602. Using form 602, the user may either enter a bid and submit the bid, or choose to buy the offer at a given price by selecting the appropriate button (e.g., the “get it now” button). If the user chooses to bid, the user enters an amount that the user feels is competitive enough to “win” the offer. If the user chooses to buy the offer (e.g., using the “get it now” button), the user will acquire the offer at the listed price. Form 602 may further include offer information (e.g., particular terms and conditions, product details, availability information, etc.), a timer for how long the offer will be made available, or other bid-related information.

User interface 600 further includes offer information 604. Offer information 604 may include merchant information for the merchant providing the offer. For example, a merchant logo or pictures 606 may be displayed, general information 608 about the merchant and offer may be listed, “fine print” information 610 may be listed which provides the user with the detailed terms of the offer, and location information 612 may be listed which provides the user with directions to or a map of the location of the merchant and/or offer.

User interface 600 may further include various modules. For example, a social networking module 614 is shown that allows a user to email the offer or share the offer via a social networking site. User interface 600 also includes a nearby offer module 616 that allows a user to view offers similar to the current offer being displayed.

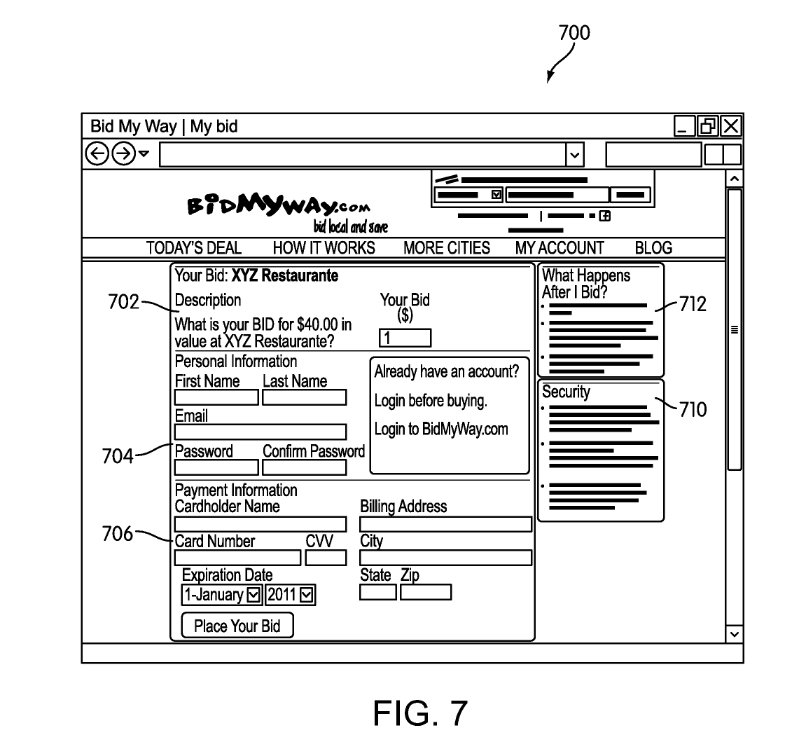

Referring to FIG. 7, user interface 700 may be accessed by a user to provide payment information and other information. When a user selects to bid on or buy an offer, using form 702, the user may confirm or change the bid or purchase price. In form 704, the user may enter personal information (e.g., name, password, email) associated with the user subscription/account (or confirm such information if the bidding system already has the information). In form 706, the user may enter payment information such as credit card information (or confirm such information if the bidding system already has the information). User interface 700 may generally include a security window 710 detailing the process of submitting information through the user interface to the bidding system, and an additional window 712 to describe the bidding process and any other relevant information. User interface 700 may further include other forms for user input of various offers details (e.g., a quantity of offers the user wishes to buy or bid on).

Referring now to FIG. 8A, a process 800 for determining a group of winning bids (and a group of losing bids) is shown, according to an exemplary embodiment. Process 800 includes receiving multiple bids, dividing bids into multiple groups or “buckets”, and then selecting one or more winning bids from each group to populate the group of winning bids. Process 800 includes receiving bids for an offer (step 802). At the end of the bidding period, the bids are counted and sorted and the total is divided by, for example, four, in order to determine a bucket size (step 804). The bids are then equally distributed into four buckets in order of when the bids were received (step 806). For example, if 1,000 bids were received, the first 250 bids received are placed into the first bucket, the next 250 into the second bucket, etc. It should be noted that while four buckets is used as the example in FIG. 8A, it should be understood that the number of buckets may vary according to various exemplary embodiments.

Process 800 further includes determining a price threshold for user bids in each bucket (step 808), and determines winning bids in each bucket based on the price thresholds (step 810). For example, for an offer worth $100, process 800 may assign a price of $30 to the first bucket, $40 to the second bucket, and $45 and $50 to the third and fourth buckets. Assume a first user made a bid of $35 and was the 100^{th} person to bid. Therefore, being in the first bucket and making a bid over $30, the first user wins the bid and is charged $30 for the offer. Assume a second user made a bid of $35 and was the 600^{th} person to bid. Therefore, being in the third bucket and making a bid less than $45, the user loses the bid and is not charged.

Referring now to FIG. 8B, a different way to fill the “buckets” is shown in a process 850. After receiving the bids and sorting the bids based on when the bids were received (steps 852, 854), instead of equally filling the four buckets, process 800 divides the bids into four buckets based on a merchant (or bidding system) decision for bucket sizes (step 856). For example, based on a merchant preference, the first bucket may only contain the first 50 bids, the second bucket the next 100 bids, the third bucket the next 200 bids, and the fourth bucket all remaining bids. Process 850 then determines a price threshold for each bucket (step 858) and determines winning bids (step 860) as described in FIG. 8A.

The bidding system described in FIGS. 2-8 may include various bid limitations. For example, according to one exemplary embodiment, if the user decided to enter a bid for an offer, the system may restrict the user to only one bid for a specific offer or product. In an exemplary embodiment, the system may restrict the user to one total bid per day. In another exemplary embodiment, the system may restrict the user to only one bid per product category (e.g., restaurants, movies, games, shows, etc.). When the next day arrives, the system may reset the user's ability to bid (e.g., on specific products, on product types, etc.). In another exemplary embodiment, more than one bid may be entered by the user prior to the system informing the user that no further bids are being accepted. In yet another exemplary embodiment, the user may be limited to one bid until a group of winning bids and group of losing bids are determined; after which the user may then submit another bid.

According to one exemplary embodiment, the system may include a bid threshold to apply to losing bids. Each offer may include a bid threshold that is less than an acceptable price for the offer. The bids that are below the threshold for a given offer may result in no further bids being allowed by the system for that user for the day. If the user submits a bid above the threshold for a given offer, the system may allow the user to submit another bid for the offer. When a bid is below the threshold, the system may provide the user with an indication that the bid was too low and that this is the reason the user must wait until the next day to submit a subsequent bid. When a bid is above the threshold, the system may provide the user with an indication that the bid was not accepted but is close enough for the user to receive another chance at entering a winning bid.

Referring generally to FIGS. 9-21, systems and methods for presenting real-time (e.g., quasi real-time) discount offers to a user accessing a computerized system (e.g., a bidding system) are shown according to another exemplary embodiment. The systems and methods of FIGS. 9-21 allow a user to ask for and view multiple related offers, and further allow the user to select and purchase one of the offers via the bidding system of FIG. 1. For example, a user may indicate a preference for a type of offer (e.g., restaurant offer, sports tickets, movie tickets, etc.) and a bidding system may provide one or more offers that most closely match the user preference. The user may then select an offer to view more information on the offer, and choose to purchase the offer, and provide payment information to pay for the offer.

The user may further, when indicating preferences for offer types, provide the bidding system with user parameters such as cost, type of offer, and date of offer. The user parameters may be submitted to the bidding system via a graphical user interface provided by the bidding system. The graphical user interface may include controls for “locking” or “unlocking” one or more parameters or subsets, and the bidding system may present a list of offers to the user based on “locked” parameters (e.g., user-preferred parameters) and based on a random or pseudo-random selected “unlocked” parameters (e.g., parameters for which the user did not specify a specific value). For example, if the user selects a “locked” parameter of a specific date and an “unlocked” parameter of no specified budget, the bidding system may provide offers relating to the specific date but with no regard for the price of the offer.

Referring now to FIG. 9, a flow chart of a process 900 for allowing a user to view and buy offers on a user device (e.g., a mobile phone) is shown, according to an exemplary embodiment. Process 900 includes receiving user account information (step 902) from a user device. The user account information may include new account information (e.g., for a new user wishing to subscribe to the bidding system), account and preference changes (e.g., from a returning user), user login information (to allow returning users to login to the bidding system), etc.

Process 900 further includes receiving user location information (step 904). The user location information may be detected via GPS information associated with the mobile phone or other user device of the user, may be determined via the IP address of the user device, may be received as an input from the user, or otherwise.

Process 900 further includes receiving user interest information (step 906). The user interest information is used by the bidding system to determine the type of offers to provide to the user. User interest information may indicate a preference for, for example, sporting or movie tickets, spas, shows, restaurants, and other attractions. Steps 902-906 of receiving various user information is shown in greater detail in FIGS. 10-13.

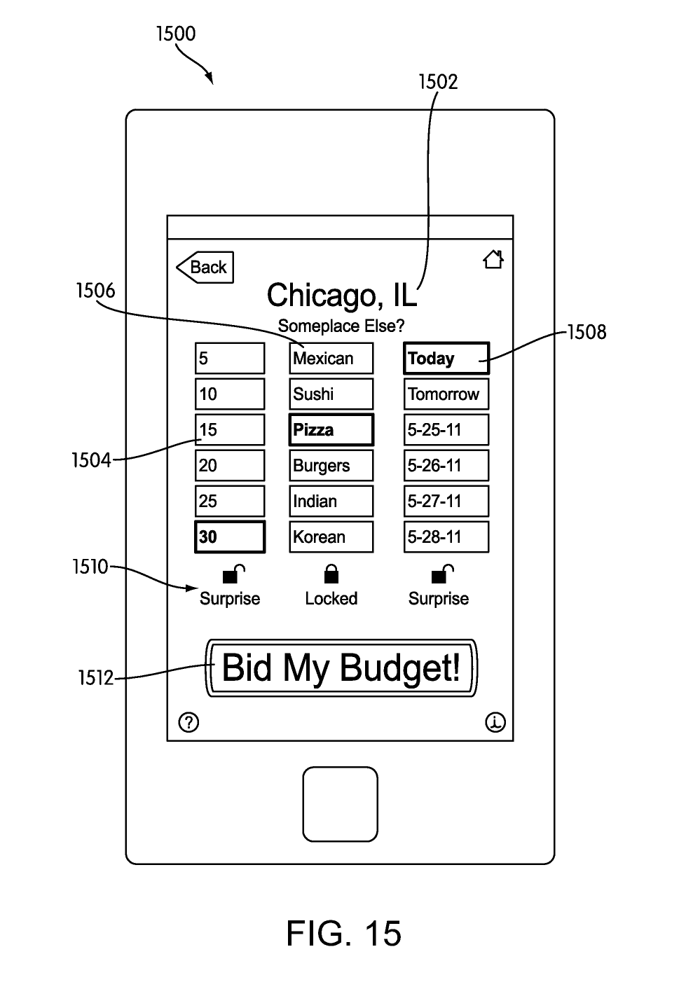

Process 900 further includes receiving user offer information (step 908). User offer information (e.g., user parameters) allows process 900 and the bidding system to select the type of offers to provide to the user. For example, user offer information or parameters may include a user budget (e.g., a specified price range for which the user is willing to spend on an offer), user interest preferences (e.g., information obtained in step 906), and a date or time (e.g., a specified range of times or dates for which the user will be able to redeem the offer). Step 908 may further include, prior to receiving the user offer information, providing a user interface to the user for selecting the offer information. The user interface may allow the user to select “locked” information or parameters (e.g., a parameter that all offers provided to the user should include) and “unlocked” information (e.g., a desired parameter for an offer; although the offer may deviate from the desired parameter). For example, step 908 may include providing a list of options for the user to select in various ways. One such embodiment of selection of offer information is shown in FIG. 15.

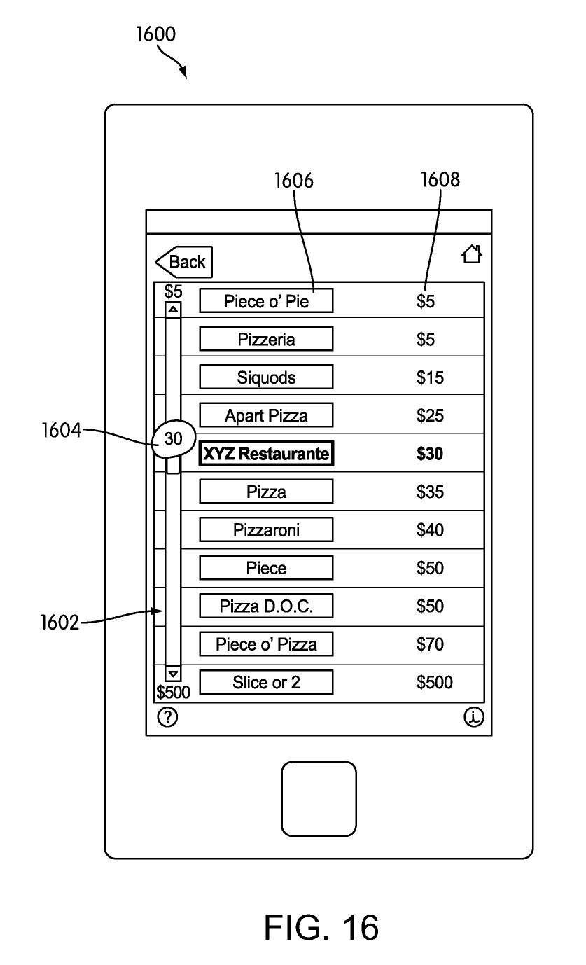

Process 900 further includes providing offers to the user based on the user offer information (step 910). The offers provided are related to the user offer information (e.g., if the user wanted restaurant offers, process 900 provides all restaurant offers that are a best fit for the user budget). For example, if user offer information included locked parameters and unlocked parameters, step 910 may include selecting all offers that match the locked parameters and then randomly or pseudo-randomly selecting from the offers based on a random or pseudo-random selection of an unlocked parameter. According to an exemplary embodiment, the provided offers may be adjusted based on the number of offers already sold to other users (e.g., if, for a particular offer, there is a limited quantity of the offer available, the price of the offer provided to the user in step 910 may be adjusted based on the remaining quantity of the offer). One such embodiment for displaying offer information to the user is shown in greater detail in FIG. 16.

According to an exemplary embodiment, step 910 may further include using user history and demographics in addition to user offer information to provide offers to the user. For example, the bidding system may track user history and demographics (e.g., past purchases and bids of the user in the bidding system, types of offers bid on, etc.) and use the user history and demographics to select the offers to provide to the user. Further, the offer itself may be adjusted (e.g., price of the offer) based on the user history and demographics. For example, if the user previously provided a positive review of an offer or of a merchant providing the offer, the price of the offer to be provided to the user may be lowered.

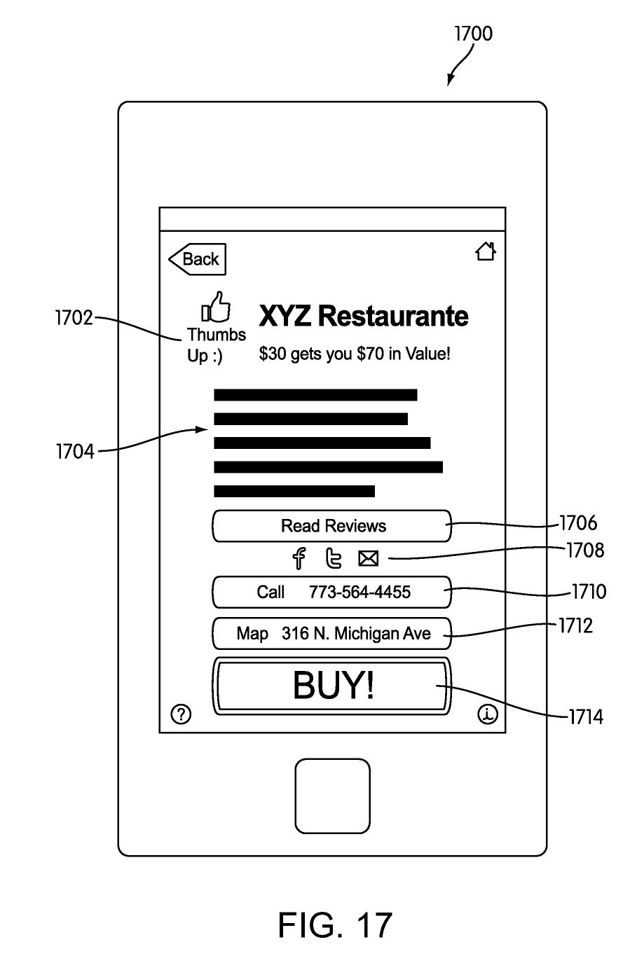

Process 900 further includes receiving an offer selection from the user (step 912). The user may select the offer from the display provided by the bidding process in step 910. Upon selection of the offer, process 900 includes providing offer information to the user (step 914). Offer information may include the price of the offer, savings of buying the offer at the given price, merchant information for the merchant providing the offer, user reviews of the offer, offer location details, etc. One such user interface for providing the information of step 914 is shown in FIGS. 17-19.

Process 900 includes receiving indication of the user purchase (e.g., a confirmation) (step 916). Process 900 further includes completing the transaction (step 918). Completion of the transaction may include, for example, providing a voucher to the user to redeem for the offer.

Referring generally to FIGS. 10-21, illustrations of exemplary user interfaces (e.g., for providing process 900) are shown. The embodiments of FIGS. 10-21 are shown as provided on a mobile phone. According to other various exemplary embodiments, the user interface of FIGS. 10-21 may be provided on another user device (e.g., desktop, laptop, tablet, PDA or other handheld device, etc.).

The user interfaces of FIGS. 10-21 may generally include navigation buttons that allow the user to access various functions of the bidding system. For example, a navigation button may be provided that allows the user to go to a home page or other user interface of the bidding system (via a home icon) to restart the process of generating offers, and a FAQ button may be provided that allows the user to access help topics for using the user interface (via a question mark icon).

Referring to FIG. 10, the bidding system locates the user and displays the result on user interface 1000 (e.g., displaying Chicago in field 1002). The system may locate the user by analyzing the IP address of the user, the carrier, WiFi hotspot, or cellular tower of the user, by receiving location information from the user's mobile computing device (e.g., receiving GPS information from the user's GPS-enabled mobile phone, etc.). If the location cannot be found, the system may ask the user to enter location information (e.g., address, city, state, zip code, landmarks, etc.) and display a message indicating the system does not know where the user is. Additionally, in field 1002, the user may have the option (e.g., via a selectable link) to select an alternate location by entering new location information.

The user may then select (e.g., via combo box 1004 shown in FIG. 10) what he or she is interested in (e.g., spas, movies, sports, etc.). The user may further choose to create an account via link 1008. The user will have to create an account before purchasing an offer. After the location and interests are selected by the user, the user may select icon 1006 to access offers. If the user selects icon 1006 before specifying a location and/or interest, the user may be prompted to enter such information before moving on, or the system may provide a default setting for the user.

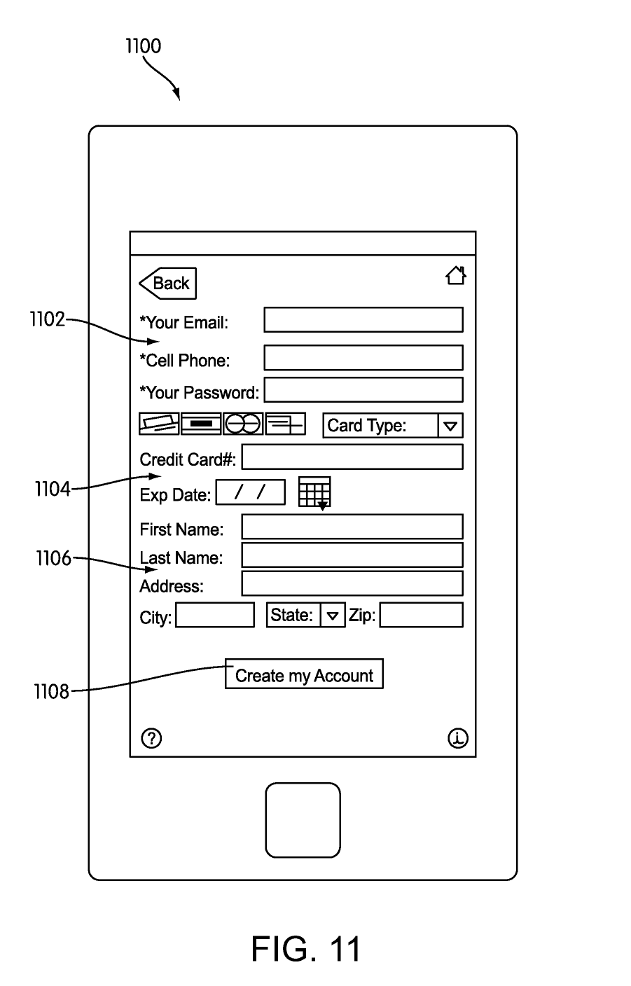

Referring now to FIG. 11 and user interface 1100, the user may set up his/her account. Account information includes user e-mail, phone number, and password that may be entered using form 1102. Further, credit card information may be required to be provided by the user (e.g., credit card type, card number, expiration date) via form 1104 and user information (e.g., first and last name, address, city, state, zip code, etc.) via form 1106. When finished, the user selects icon 1108 to submit the information.

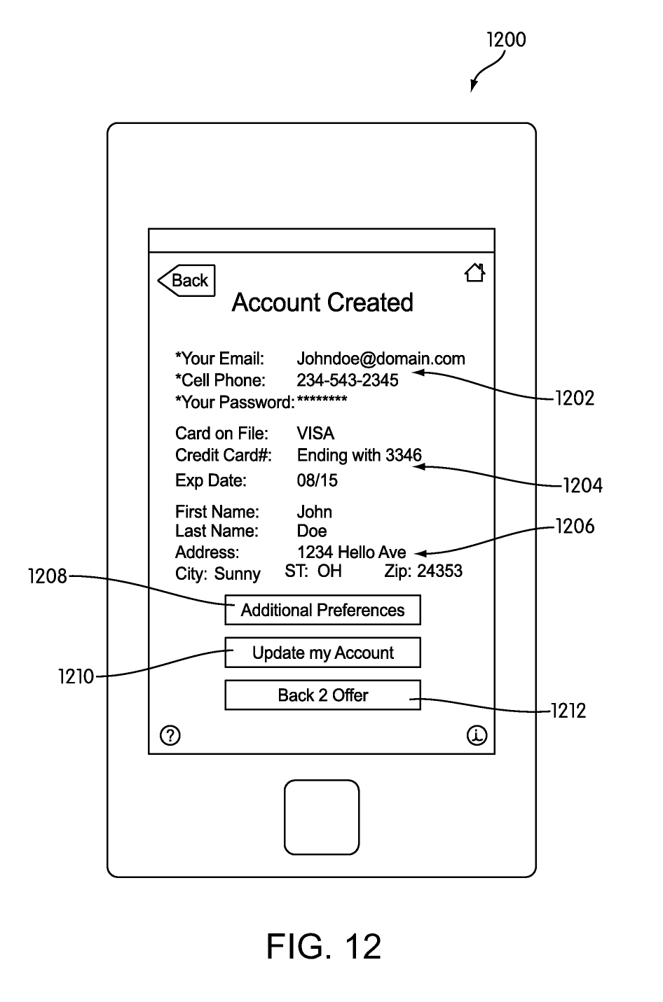

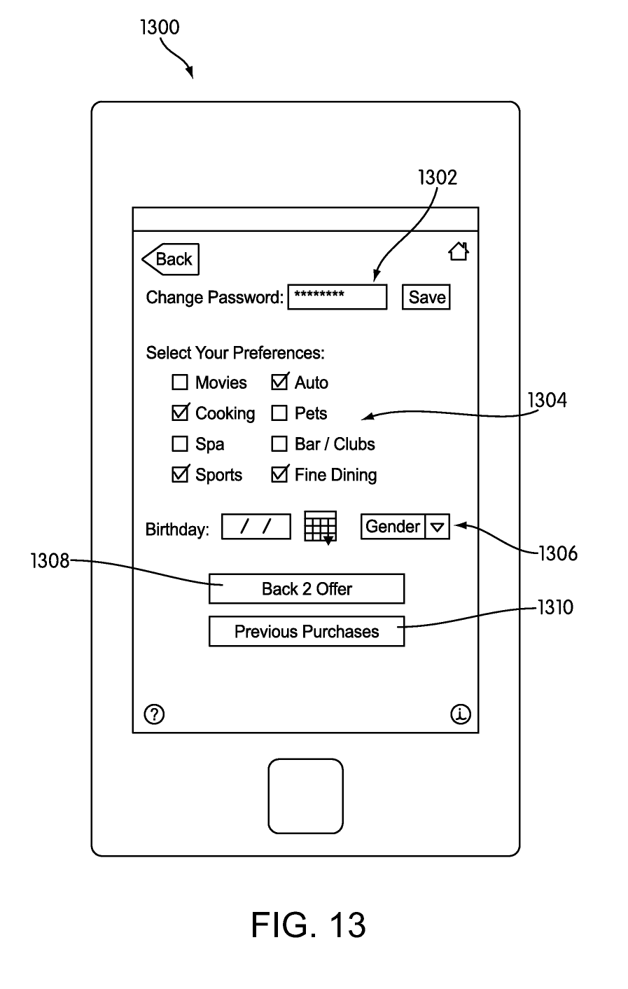

Referring now to FIG. 12 and user interface 1200, the saved account information, credit card information, and user information is displayed to the user via forms 1202, 1204, 1206. The system indicates to the user that the account is created and further allows the user to select a button 1210 to edit the displayed information. If the account was created while the user was in the middle of purchasing an offer, a button 1212 for the user to return to the offer is provided. Additionally, a button 1208 to allow the user to provide additional preferences is provided that takes the user to the screen shown in FIG. 13.

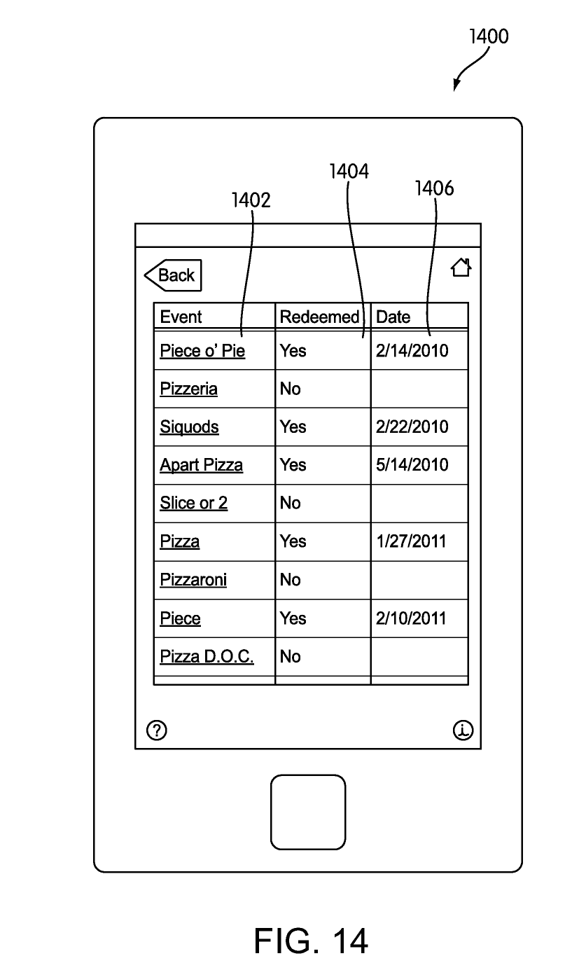

Referring now to FIG. 13 and user interface 1300, if the user desires, the system provides a screen for the user to edit preferences. For example, the user may change a password using form 1302, select which types of offers they are interested in (e.g., movies, cooking, etc.) using checkboxes 1304, indicate birthdays and gender via form 1306, etc. The system may include a button 1308 to return to an offer and a button 1310 to access previous purchases of the user (shown in FIG. 14).

Referring now to FIG. 14 and user interface 1400, previous purchases are shown in table form. The table includes the event in column 1402 (e.g., the product that was purchased). The event may be selected by the user and if an offer for the event is still valid or available, the user may select it for re-purchase. The table further includes an indication if the offer was redeemed or not in column 1404. The table also includes a date at which the offer was redeemed (if redeemed) in column 1406.

Referring now to FIG. 15, a new screen 1500 (e.g., the “slot machine”) is shown to the user. The “slot machine” interface 1500 shown in FIG. 15 may allow a user to specify the types of offer he or she receives. User interface 1500 includes three categories: budget 1504, vertical specifics 1506, and date 1508. Budget column 1504 may include prices that increase in set increments (e.g., $5 increments, $1 increments, etc.). The user may choose a price in column 1504 representative of how much money the user is willing to spend on an offer. Vertical specifics column 1506 relates to the selection of product category or type that the user is interested in. For example, if the user had indicated an interest in food, the user may then select the type of cuisine in column 1506 (e.g., pizza, Mexican, Indian, etc.). Date column 1508 relates to a date or date range within which the user wishes to redeem a potential offer. The user may “lock in” any of the three choices by selecting a lock icon 1510 below one of the lists. Otherwise, the system may “spin” (e.g., randomize, provide a random look and feel without actually being random) a category's options if the lock icon was not selected. For example, in the embodiment of FIG. 15, the bidding system will “spin” between options in the price and date columns as the user has not locked in a choice for either option. The user may select button 1512 to “spin” between the options and/or advance to view offers once the choices are made. User interface 1500 further includes location field 1502 in which the user may provide any updated location information. Field 1502 may be used by the bidding system in order to provide offers local to the user.

Referring now to FIG. 16, the result of the selection of button 1512 is shown in user interface 1600. A table with a merchant column 1606 and price column 1608 is shown. Column 1606 displays the merchant providing the offer. The results are sorted by price, then alphabetically. For example, the scrolling bar 1602 is shown to range from $5 to $500, and the price selected by the user (e.g., $30) is highlighted at button 1604. The resulting offer that most closely matches the price is shown in the middle of the list of offers, with lower priced offers above it and higher priced offers below it. The most closely matching offer may be highlighted. The user may select an offer on the list, and the system then shows the screen shown in FIG. 17.

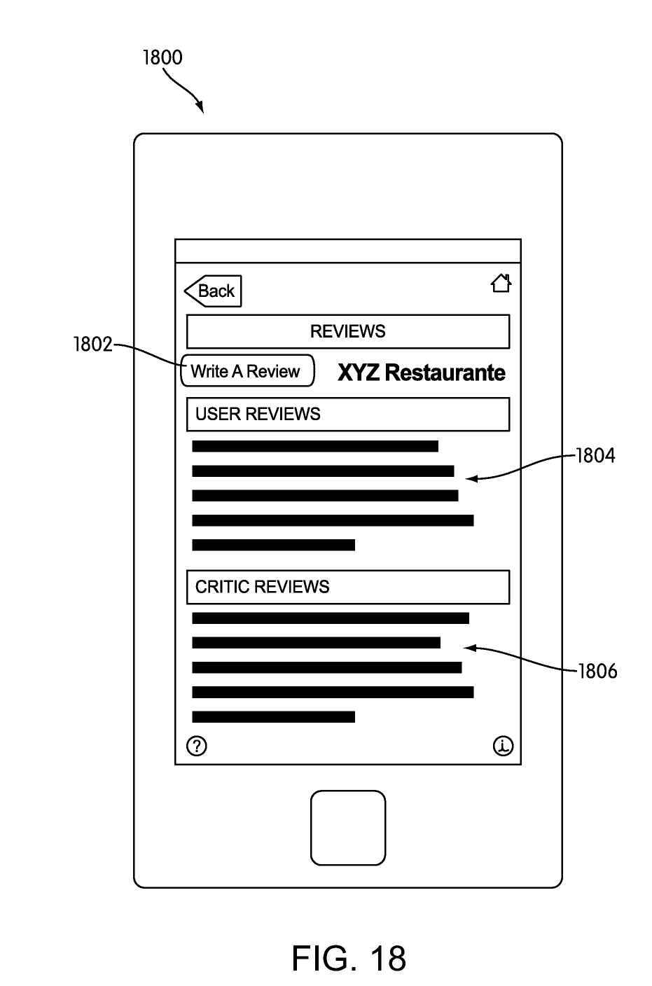

Referring now to FIG. 17 and user interface 1700, the screen shows information on the chosen offer from FIG. 16. The user may choose to “like” or “don't like” the offer or the merchant associated with the offer by selecting a thumbs up or thumbs down icon 1702. User interface 1700 includes a general description 1704 of the offer and merchant. Via the screen shown in FIG. 17, the user may additionally select various links to view more information about the offer. For example, by selecting the “read reviews” button 1706, the user is taken to user interface 1800 of FIG. 18 which shows user reviews of the offer and/or merchant. The user may select button 1802 to write a review for the offer and/or merchant, the user may read user reviews in a window 1804, and the user may read critic reviews in a window 1806.

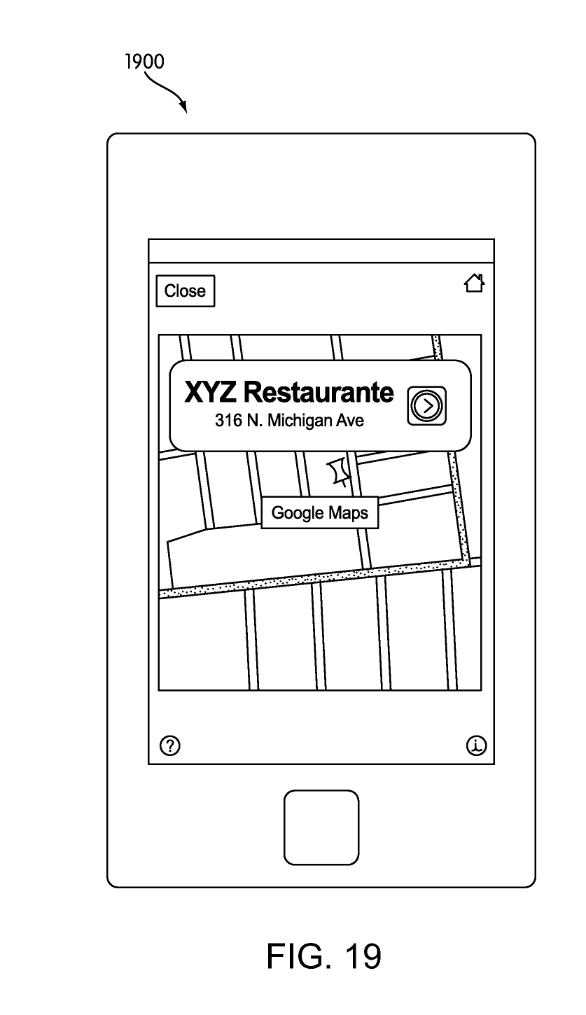

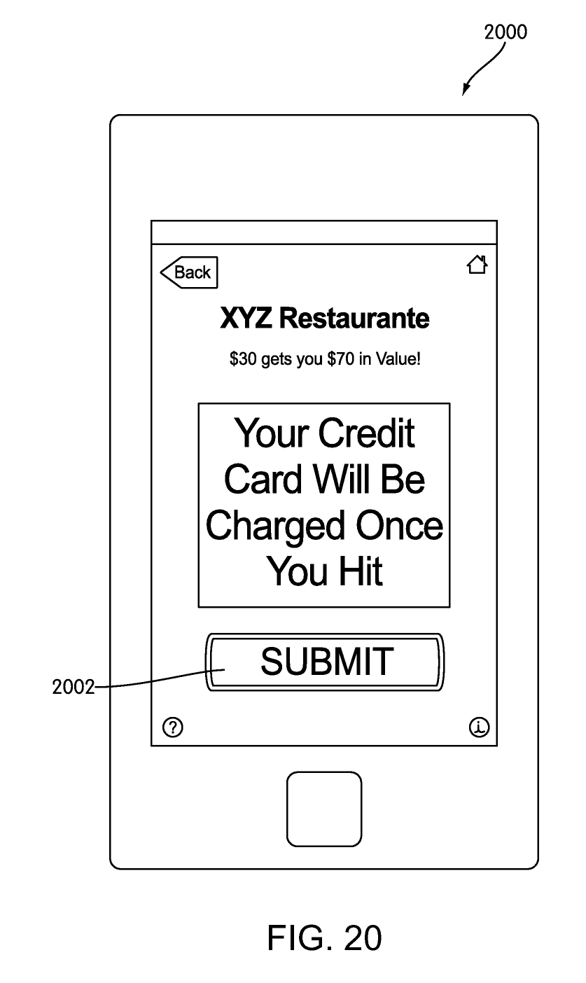

Referring again to FIG. 17, buttons 1708 are buttons that allow the user to interact with social media (e.g., social networking sites, email, etc.). It should be understood that while the embodiment of FIG. 17 shows buttons 1708 for interacting with social media, such buttons may be included on any of the user interfaces of FIGS. 10-28 and may allow the user to interact with the social media or social network by sharing offers, offer information, and other information provided by the bidding system. Selecting “call” button 1710 allows the user to call the merchant. Selecting “map” button 1712 allows the user to view a map and/or directions to the location of the offer (shown in user interface 1900 of FIG. 19). Selecting “buy” button 1714 takes the user to the user interface 2000 of FIG. 20 so that the user may purchase the offer (if the user does not have an account, the user may then be taken back to the screen of FIG. 11 to create an account). In addition to “buy” button 1714, in an exemplary embodiment, an option to submit a bid that is different than the buy offer may be presented to the user (e.g., via a button, offer field, or otherwise). The bid submission, processing, accepting, or denying processes may be as described above with respect to the processes of FIGS. 2A-B (e.g., the “bid my way” process).

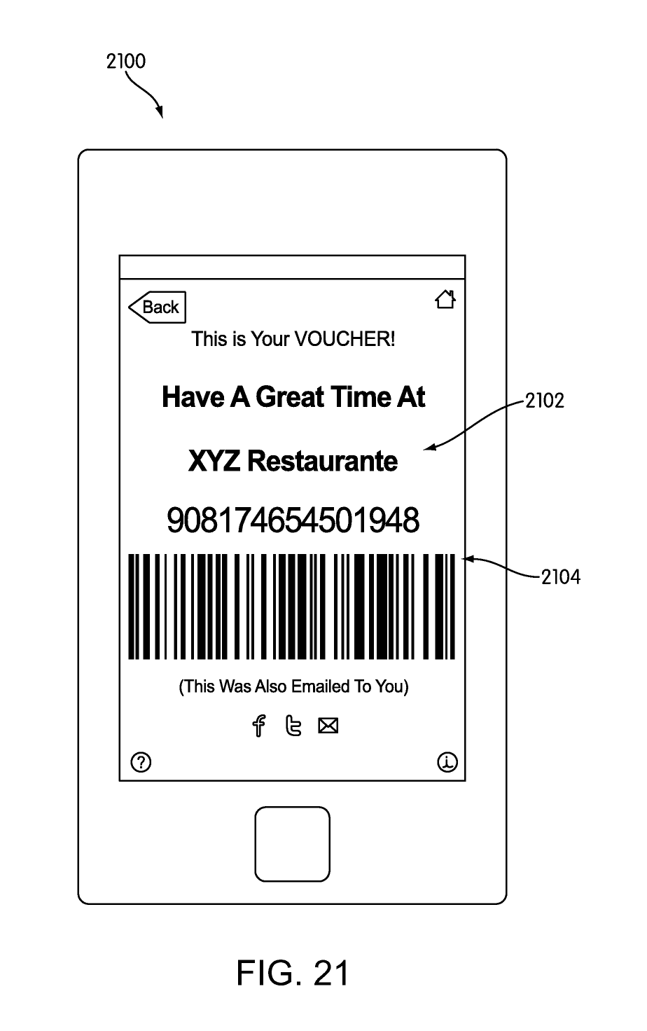

At user interface 2000 of FIG. 20, information about the offer to be purchased is shown. Selecting “submit” button 2002 submits the offer to the system. In FIG. 21, the system, upon completion of the purchase, provides the paid voucher for the order. The voucher includes a unique ID and barcode 2104 as well as generic information in field 2102. The voucher may be automatically emailed to the email address of the account for the user and/or automatically emailed to the merchant. The voucher is used by the user to redeem the offer or product purchased and by the merchant for redeeming the voucher with the bidding system.

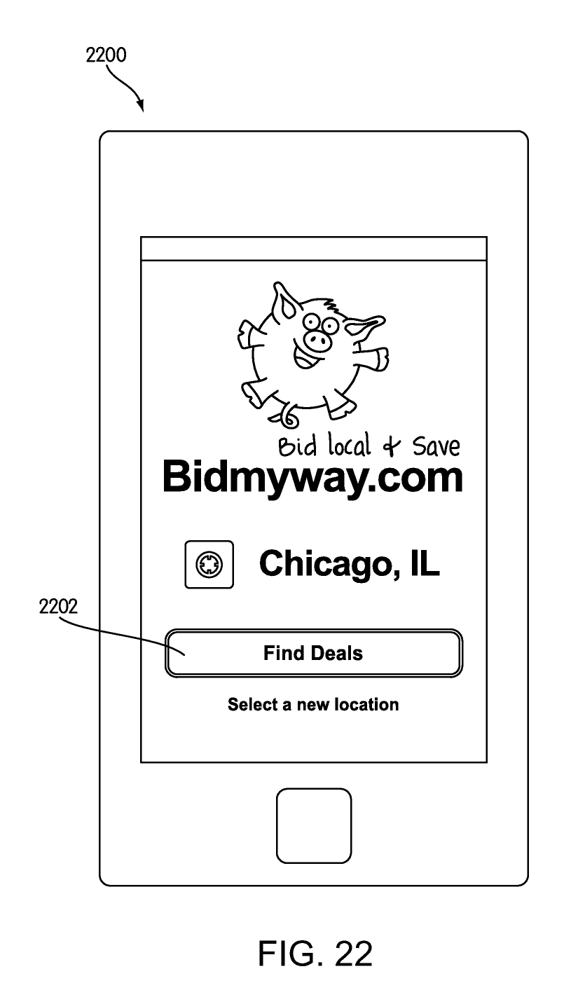

Referring now to FIGS. 22-25, systems and methods for presenting real-time (e.g., quasi real-time) discount offers to a user accessing a computerized system (e.g., a bidding system) are shown according to yet another exemplary embodiment. Compared to the user interfaces shown in FIGS. 9-21, the user interfaces shown and described in FIGS. 22-25 illustrate systems and methods for allowing a user to specify a type of offer without entering other offer information (e.g., any timeframe or cost associated with the offer, as shown in, for example, FIG. 15).

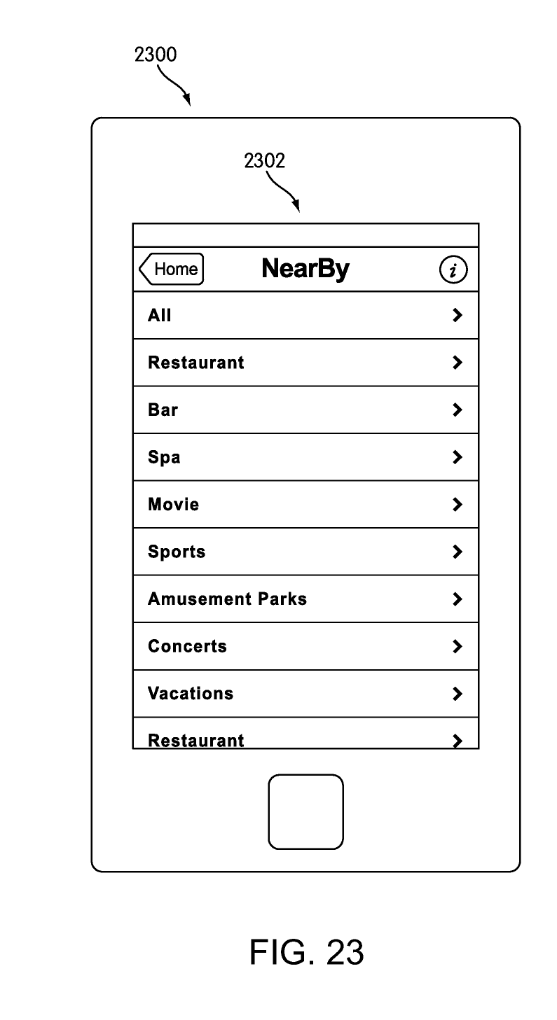

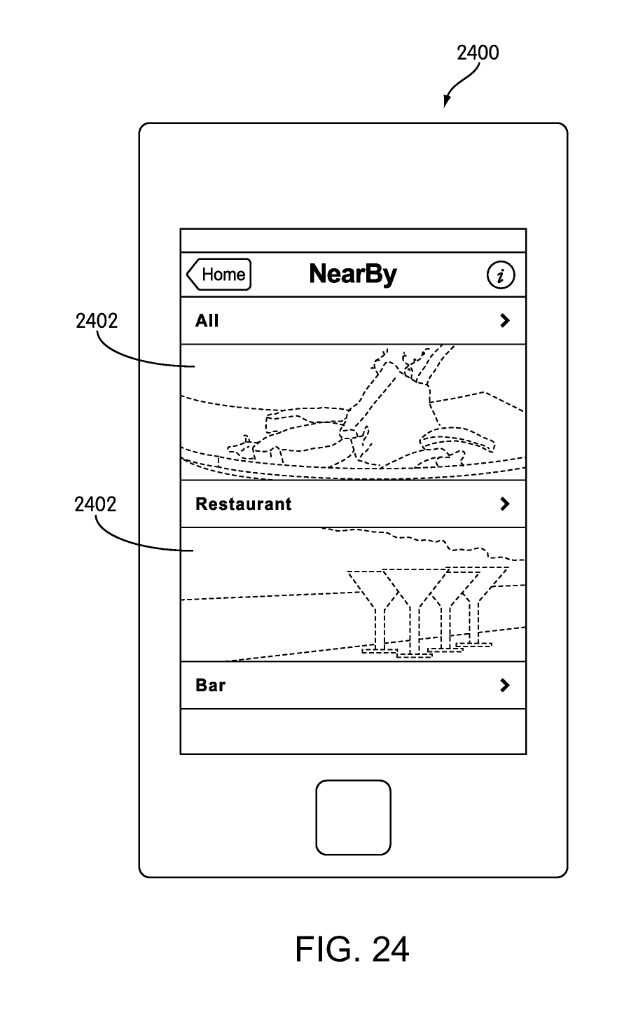

Referring to FIG. 22 and user interface 2200, a user may select “find deals” button 2202 to begin searching for offers. The user may further indicate or select a new location for which to browse offers from. Referring to FIG. 23 and user interface 2300, the user may be provided with a list 2302 of type of offers (e.g., restaurant, bar, spa, etc.) and the user may choose an offer type (or choose the “all” selection to view all offers for all categories). Further, if the user selects one of the offer types, the user interface of FIG. 23 may be configured to “expand” a menu of choices under the offer type for the user to browse and select. Referring now to FIG. 24, another user interface 2400 for viewing offer types is shown. In FIG. 24, user interface 2400 may display pictures 2402 representative of the offer type (e.g., food for the “restaurant” option).

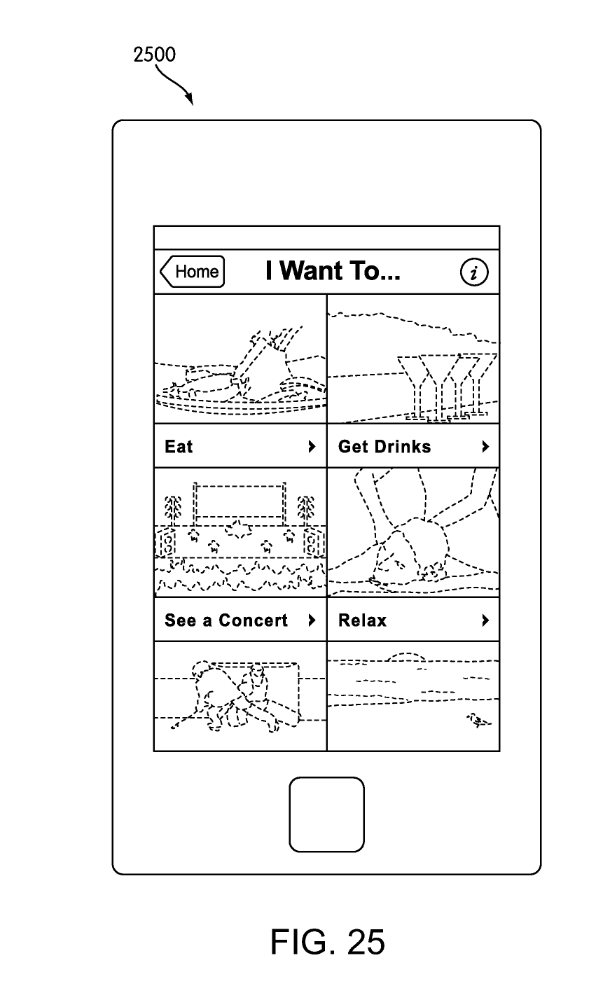

Referring now to FIG. 25, user interface 2500 displays offer types based on the type of activity the offer includes rather than specifying a location or business type. For example, instead of providing a “restaurant” option, the user interface displays an “eat” option. The bidding system of the present disclosure may be configured to display offer types by the type of business providing the offer or by the type of activity provided in the offer.

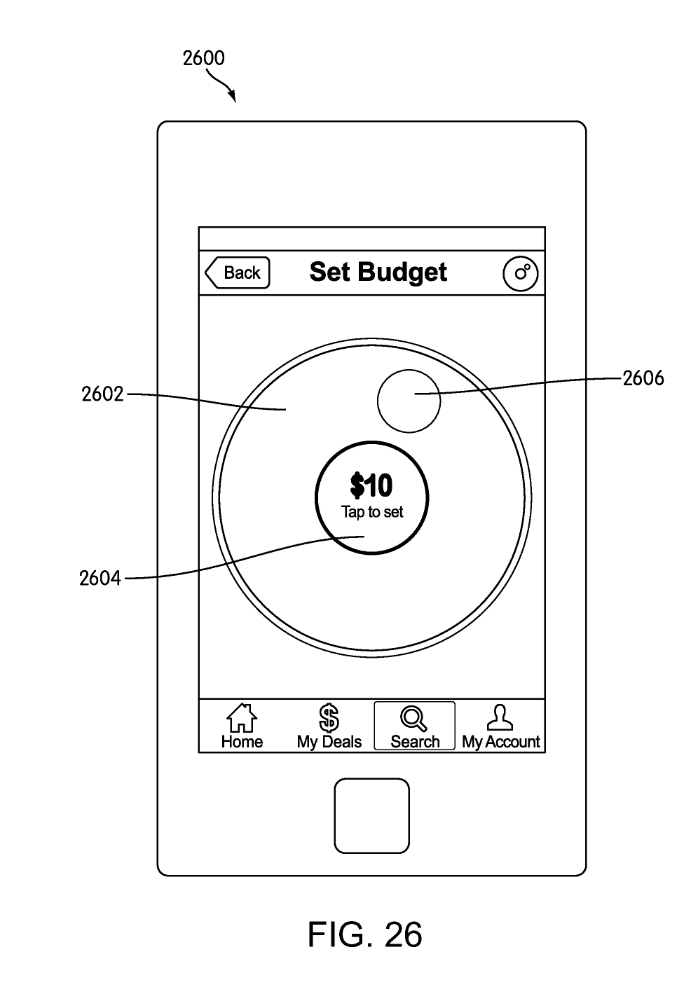

Referring to FIGS. 26-28, additional systems and methods for presenting real-time (e.g., quasi real-time) discount offers to a user accessing a computerized system (e.g., a bidding system) are shown. Referring now to FIG. 26, user interface 2600 shows a graphical user interface dial 2602 which may be used by a user of the bidding system to set a budget. By operating dial 2602, a user may set a preferred budget (e.g., a price limit or range that the user is willing to spend for an offer). The bidding system may receive an input from the user via dial 2602 and select offers that fit the price range or target specified by the user via the dial.

Dial 2602 includes a center button 2604 and a rotation element 2606. Center button 2604 is configured to show a target price to the user. According to one exemplary embodiment, the target price represents an upper limit of what the user is willing to spend on an offer. The target price may otherwise represent a lower limit of what the user is willing to spend on an offer, a price for which the bidding system should provide offers that are closest to the target price, or another price. When the user achieves a desired target price, the user may tap button 2604 to set the price. Upon tapping button 2604, the bidding system may receive the set price and generate offers to display to the user based on the set price. According to various exemplary embodiments, button 2604 may be operated in other ways than a tap (e.g., a press, a press for longer than 1 second or another timeframe, a double tap, or another user input to the mobile phone).

User interface 2600 and dial 2602 may be configured to change appearance upon tapping of button 2604 by the user. For example, button 2604 may appear as a three-dimensional button to the user and may simulate the appearance of being pressed down upon being tapped by the user. As another example, button 2604 or dial 2602 may be shaded or darkened when the user taps the button. The mobile phone may be configured to play a sound effect (e.g., a clicking sound) upon operation of button 2604.

Rotation element 2606 may be used to set a current price by a user. Using rotation element 2606, the user may increase or decrease the target price by placing a finger (or other object designed to touch or operate the mobile phone) on rotation element 2606 and sliding the finger around dial 2602. For example, sliding rotation element 2606 in a clockwise direction around dial 2602 may result in increasing the target price by a set amount (e.g., sliding rotation element 2606 by 30 degrees may result in the target price incrementing by $5) and sliding rotation element 2606 in a counterclockwise direction around dial 2602 may result in decreasing the target price. According to an exemplary embodiment, the target price may change based on how the user is operating rotation element 2606. For example, the faster the user rotates element 2606, the faster the target price may increase or decrease as a result (e.g., when the rotation of element 2606 is faster than a threshold, the target price may increase or decrease by a larger increment per degree). As one example, if the user rotates element 2606 in a clockwise direction by 180 degrees, and the default increment for the target price due to the rotation is $100, the target price may actually increment by $500 if the speed of the rotation is five times faster than normal (or above a rotation speed threshold).

Rotation element 2606 is shown as a small circular area on dial 2602; according to various exemplary embodiments, rotation element 2606 may be another shape. For example, rotation element 2606 could be a bar that the user can slide up or down to adjust the target price. Dial 2602 is shown as a circular shape; according to various exemplary embodiments, dial 2602 may be another shape (e.g., spherical, cubical, rectangular, etc.). It should be understood that the shape of dial 2602, button 2604, and rotation element 2606 and the location of the various elements of dial 2602 may be changed without changing the operation of dial 2602 as described herein. For example, button 2604 may be located outside of dial 2602, rotation element 2606 may be implemented on the edge of dial 2602, etc.

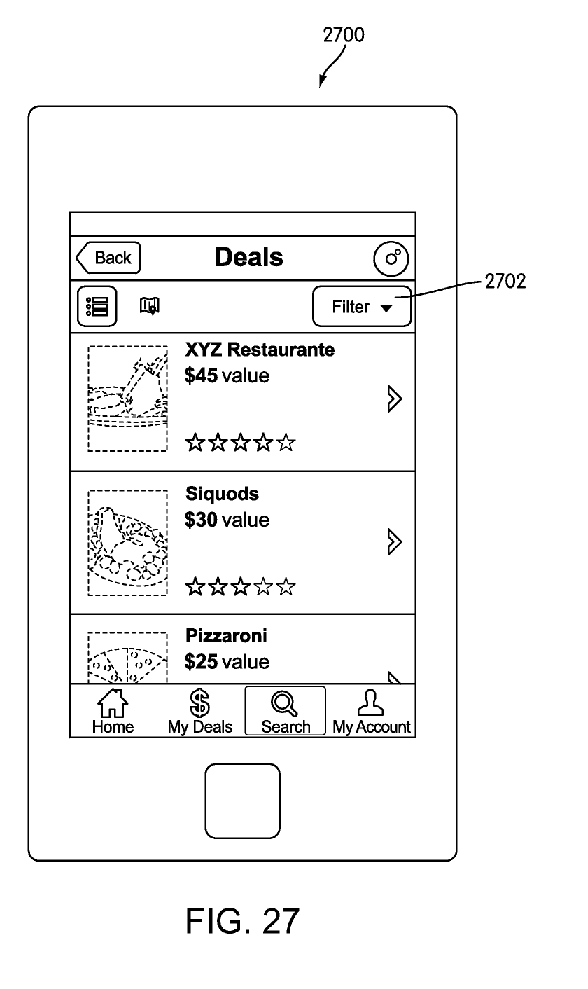

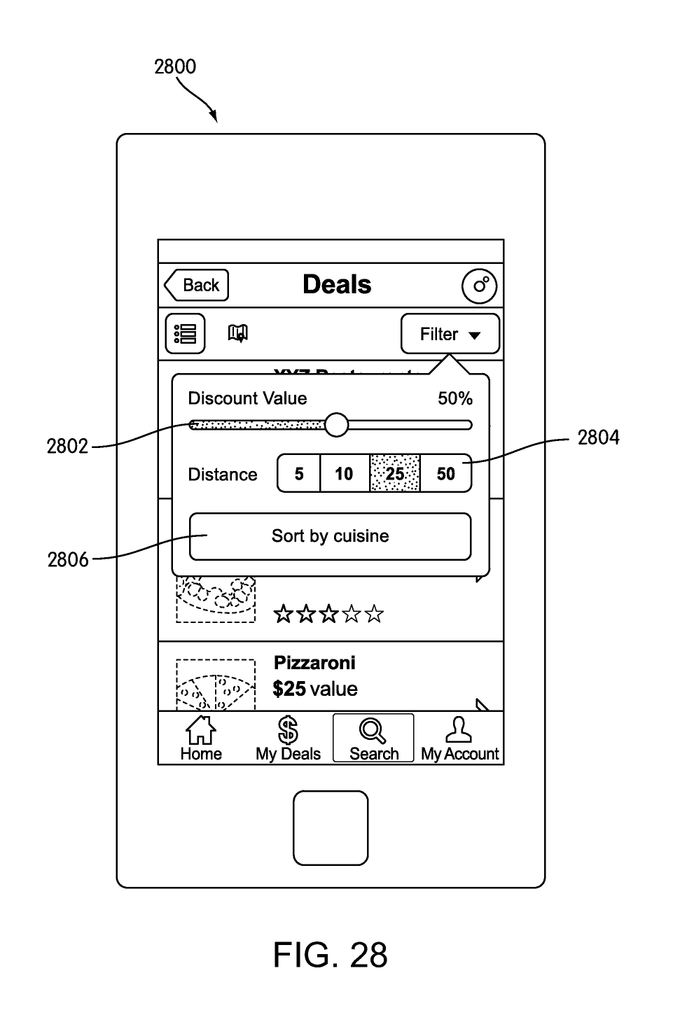

Referring now to FIG. 27, user interface 2700 shows a list of offers. Each offer includes information such as the merchant providing the offer, the price of the offer, and a rating for the offer and/or merchant. User interface 2700 further includes a filter button 2702. Filter button 2702 may be selected by a user. Referring now to FIG. 28, upon selection of filter button 2702, a number of options are provided to the user to adjust the types of offers shown on user interface 2800. For example, using slider 2802, the user may adjust a threshold for discount value. The discount value may relate to a percentage of savings provided by a particular offer. For example, if slider 2802 is set at 50%, only offers which provide at least a 50% savings from a retail price or normal price may be provided to the user.

User interface 2800 further includes other elements for adjusting the type of offer provided to the user. For example, a distance button 2804 is shown that allows a user to filter offers based on distance away from a user or a preselected address. For example, the user may filter out all offers for which the merchant is at least 25 miles away from the user. User interface 2800 further includes a sort button 2806 that allows a user, upon selection of button 2806, to sort offers based on the type of offer (e.g., for food offers, sorting by cuisine type). User interface 2800 may further include any type of slider, button, or other elements for filtering and sorting offers based on location, price, or type of offer.

Referring now to FIG. 29, a flow chart of a process 2900 for providing merchant access to the computerized system of the present disclosure is shown, according to an exemplary embodiment. Process 2900 allows a merchant to create an offer and offer discount for providing to users. Process 2900 includes receiving and accepting an offer contract from the merchant (step 2902). When an offer contract (e.g., a contract relating to how the offer is to be provided by the bidding system) is signed or agreed to between the merchant and computerized system for an offer, the offer may be built and provided by the computerized system. Process 2900 further includes providing access to the bidding system for the merchant (step 2904). For example, the bidding system may provide an access code to the merchant, login information to the merchant, etc. Process 2900 further includes receiving merchant login information (step 2906). Upon accessing the bidding system, if the merchant does not have an account set up with the bidding system, the merchant may set up an account using the access code (e.g., a password) during step 2906. In future visits, the merchant can then use the account to access the bidding system.

Process 2900 further includes providing offer information for the merchant to view and edit (step 2908). Upon logging in, the merchant is able to view their offer that were built by the bidding system. A screen may be provided that displays all of the offers that the merchant has made available. The offers may be sorted by current offers, scheduled offers (offers scheduled to run at particular times and dates), past offers, and into a calendar view that allows the merchant to see what dates its offers will be available.

In an exemplary embodiment, step 2908 may include the computerized system being configured to provide a merchant's computing system or user interface with market information. For example, the computerized system may track buying behavior of users that bid on the merchant's products or services. The computerized system may also track buying behavior or characteristics of users that viewed but did not bid on the merchant's products or services. The computerized system may be configured to aggregate data and to analyze data for showing to the merchant. For example, the computerized system may be configured to provide the merchant with an indication of the merchant's top demographic group (e.g., in terms of age, location, occupation, product and service preferences, other products bought, etc.). The computerized system may provide the merchants with access to portions of raw data and/or summaries of the data.

Process 2900 further includes receiving and saving changes to offer information from the merchant (step 2910). The merchants have the ability to edit existing offers tied to their own account. Upon selection of an account, the merchant may access an edit offer screen that allows the merchant to change offer information. For example, the price of the offer may be raised or lowered, the number of vouchers available for the offer may be changed, the days and times for when the offers are available may be changed, etc. Further, the merchant may schedule the offers, schedule a text/email campaign for the offers, etc. The merchant may select the category of the offer. The merchant may upload codes or certificates that uniquely identify each voucher for each offer. The merchant may provide discount codes for the offers and also provide an email to send voucher numbers to. The merchant may further view, but not edit, information such as the creation and setup of the initial offer, the artwork of the offer, reviews uploaded by users of the offers, etc.

In an exemplary embodiment, the merchant may edit schedules for the merchant's offers. The schedule for an offer may include the length of time for which an offer should be made available to a user, the price of the offer at various points in time, the number of total offers, the number of available accepted offers per day, etc. For example, the computerized system may remove an offer from the system after a merchant's specified time period has passed. As another example, the computerized system may reduce the price on an offer from the system after a merchant's specified time period has passed. As yet another example, the computerized system may remove an offer from the system once a merchant's specified number of available accepted offers per day has been reached.

Once the merchant edits an offer, the merchant may view and confirm the edits. The merchant may access a review offer screen that allows the merchant to view the offer in the same manner that a user of the bidding system would view the offer.

The merchant, in addition to accessing the bidding system via desktop or laptop, may additionally access the bidding system via a mobile device (e.g., the merchant can select past, present, or future offers, view a list of offers for a selected timeframe, change some offer information, etc.).

Referring now to FIGS. 30A-D, the computerized system and method further includes various processes 3000, 3010, 3020, 3030 for allowing merchants to verify and process vouchers that are used on merchant offers and products. Upon completion of an offer purchase, the computerized system provides a voucher to at least one of the merchant system and user. After the voucher is obtained by the merchant or user, the merchant may access the voucher in the bidding system and “redeem” the voucher. The redemption process may occur when a user presents the voucher, when an electronic device of the user containing the voucher comes within proximity of a merchant device, etc. The process of redeeming the voucher may be accomplished in various ways. For example, referring to process 3000 of FIG. 30A, the merchant may receive a voucher from the user via a printout (step 3002). After logging into or accessing the bidding system (step 3004), the merchant enters the voucher information from the printout (step 3006) to redeem the voucher.

As another example, referring to process 3010 of FIG. 30B, the voucher may be scanned by the merchant from a mobile device (e.g., phone) of the user (step 3012). Alternatively, a picture of the barcode of the voucher may be taken by the merchant. The merchant may then login to or access the bidding system (step 3014) and forward the voucher and/or barcode information captured (step 3016) via, for example, email.

As yet another example, referring to process 3020 of FIG. 30C, the merchant may receive or scan voucher information from the mobile phone of the user (step 3022). One such way to scan voucher information may be via a “bump” app (e.g., an app that transfers data from one mobile device to another), transferring voucher information from the user's mobile phone to the merchant's mobile phone. After logging into or accessing the bidding system (step 3024), the voucher information is sent to the bidding system and the merchant receives voucher status from the system (step 3026). Voucher status may relate to if the voucher is still valid for redeeming, if the voucher has already been redeemed, etc. A voucher status message is then provided to the user's mobile phone (step 3028) indicating if the voucher is available. For example, if the voucher was already redeemed, a message stating as such is provided, and if the voucher is expired, a message stating the date of expiration is provided. Process 3020 may further include the bidding system updating the voucher status to “redeemed” if the voucher is redeemed.

As yet another example, referring to process 3030 of FIG. 30D, upon receiving the voucher from the user (step 3032), the merchant may connect to the bidding system via telephone (step 3034). The merchant may then redeem the voucher by entering voucher information through the phone (e.g., via a touchscreen or keypad of a mobile phone) (step 3036).

As yet another example, the voucher may be forwarded via email to an address that the merchant has set up for redeeming vouchers via the bidding system. In an exemplary embodiment, the computer system may transmit voucher information to a merchant for the merchant to use when the user visits the merchant. For example, the merchant may have a system that automatically prints received user vouchers for pickup or mailing to the user. In another example, the merchant may only store the voucher information electronically, applying the voucher or the discount upon a user's presentation of identification (e.g., credit card, photo ID, etc.).

In any of the foregoing systems and methods, the computerized system may track user activity and provide the user with additional options, rewards, discounts, or other incentives for system specified or merchant specified activity. For example, frequent bidders may accumulate frequent bidder reward points or bidder reputation points. A number of different user activities may result in the earning of the reward or reputation points. For example, successfully completing an offer purchase may result in the addition of a number of points equal to the purchase price of the offer. In another exemplary embodiment, a losing bid may have a certain number of associated points (e.g., negative five, positive five, etc.). In yet another exemplary embodiment, a winning bid may have a static or dynamic number of points (e.g., depending on the age of the offer, the amount of the bid relative to the reserve price, etc.). In some embodiments, the reasons for particular point earnings may be shown to the user by the computing system. In other embodiments, the reasons for particular point earnings may be hidden from the user by the computing system. Points may be earned by completing other positive tasks via the system. For example, points may be earned by submitting a user review, indicating a like of an offer or business, completing a valuable user review, submitting bids that are above a “low bidder” threshold, etc. In an exemplary embodiment, the points (e.g., reputation points) may be shown with a user's ID in user interfaces where the user is presented to others (e.g., when a user contacts a merchant, when a user shows a voucher to a merchant, when a user likes a merchant, when a user reviews a merchant, when a user comments on a merchant, etc.). If a user has a high enough frequent bidder or reputation point amount, bids that would otherwise be restricted for the user may be enabled by the system. For example, if a user has a high enough frequent bidder or reputation point amount, then the system may allow the user to bid a second time rather than being locked out or prevented from bidding after a losing bid. In an exemplary embodiment, the frequent bidder or reputation point amounts can be reduced when the user uses such points. In another exemplary embodiment, the frequent bidder or reputation point amounts are never reduced.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer system, comprising:
a communications interface configured to communicate with a plurality of users via remotely located user devices;
processing electronics coupled to the communications interface and configured to collect bids for at least one of a good, service, and discount from the plurality of user devices;
wherein the processing electronics comprise a bidding module configured to determine winning bids and losing bids by comparing the bids to a floor price; and
wherein the bidding module is configured to determine whether the losing bids qualify for re-bidding by comparing the losing bids to a first merchant-established threshold difference from the floor price.

2. The computer system of claim 1, wherein the processing electronics notify the users associated with the winning bids and the users associated with the losing bids via instant graphical user interface feedback provided on the user devices.

3. The computer system of claim 2, wherein the processing electronics provides the notifications prior to receiving all of the bids for the at least one of a good, service, and discount.

4. The computer system of claim 1, wherein the processing electronics further comprise a merchant module for providing a graphical user interface to a remotely connected merchant,
wherein the graphical user interface for providing to the remotely connected merchant comprises an input tool for allowing the merchant to set a floor price for the at least one of a good, service, or discount.

5. The computer system of claim 4, wherein the graphical user interface provided by the merchant module allows the merchant to set the first merchant-established threshold difference relative to the floor price.

6. The computer system of claim 5, wherein the graphical user interface provided by the merchant module allows the merchant to set a second threshold difference relative to the floor price, wherein the second threshold difference is closer to the floor price than the first threshold difference, and
wherein losing bids below the second merchant-established threshold difference but above the first threshold difference receive a lower number of re-bids than losing bids that are above the second merchant-established threshold.

7. The computer system of claim 6, wherein the graphical user interface provided by the merchant module allows the merchant to set a second threshold difference relative to the floor price, wherein the second threshold difference is closer to the floor price than the first threshold difference, and
wherein losing bids below the second merchant-established threshold difference but above the first threshold difference are not eligible for the same price for the good, service, or discount on re-bid relative to the losing bids that are above the second merchant-established threshold.

8. The computer system of claim 1, wherein the processing electronics uses the communications interface to transmit information for allowing the remotely located user devices to enter the bids and to generate graphical user interfaces about the good, service, or discount;
wherein the information communicated from the processing electronics comprises at least one of: web page information, hypertext information, XML information, and user application information.

9. The computer system of claim 1, wherein the processing electronics causes the communications interface to transmit information to the user devices for rendering at least one graphical user interface for receiving bid information from the user.

10. The computer system of claim 9, wherein the processing electronics causes the at least one graphical user interface to include a user control that allows the user to purchase the good, service, and discount at a non-confidential price and to avoid the bidding process.

11. The computer system of claim 1, wherein the processing electronics causes the floor price and the at least one threshold difference to be hidden from the winning bidders and the losing bidders.

12. The computer system of claim 1, wherein the processing electronics causes bidding activity from other users to be hidden from any particular user;
wherein the processing electronics causes a graphical user interface shown on a user device to display social networking options,
wherein the social networking options comprise sharing information regarding the good, service, or discount via a social networking system;
wherein the social networking options comprise sharing a winning bid with a social networking contact; and
wherein the processing electronics allows the social networking contact to purchase the good, service, or discount at the same price as the shared winning bid.

13. A computerized method for providing a good, a service, or a discount to a user, the computerized method comprising:
using communications electronics to provide a plurality of user interfaces with information about the good, service, or discount;
receiving, using the communications electronics, bids for the good, service, or discount from a plurality of user devices;
using processing electronics coupled to the communications electronics to collect the received bids and to determine winning bids and losing bids by comparing the bids to a floor price; and
using the processing electronics to determine whether the losing bids qualify for re-bidding by comparing the losing bids to a first merchant-established threshold difference from the floor price.

14. The computerized method of claim 13, comprising:
hiding the bidding activity from other users from any particular user.

15. The computerized method of claim 13, comprising:
notifying the users associated with the winning bids and the users associated with the losing bids via instant graphical user interface feedback provided on the user devices.

16. The computerized method of claim 13, comprising:
providing the notifications prior to receiving all of the bids for the good, service, or discount.

17. The computerized method of claim 16, further comprising:
providing a graphical user interface to a remotely connected merchant,
wherein the graphical user interface for providing to the remotely connected merchant comprises an input tool for allowing the merchant to set a floor price for the at least one of a good, service, or discount;
wherein the graphical user interface provided to the remotely connected merchant allows the merchant to set the merchant-established threshold difference relative to the floor price.

18. The computerized method of claim 17, wherein the graphical user interface provided by the merchant module allows the merchant to set a second threshold difference relative to the floor price, wherein the second threshold difference is closer to the floor price than the first threshold difference, and
wherein losing bids below the second merchant-established threshold difference but above the first threshold difference receive a lower number of re-bids than losing bids that are above the second merchant-established threshold.

19. The computerized method of claim 18, wherein the graphical user interface provided by the merchant module allows the merchant to set a second threshold difference relative to the floor price, wherein the second threshold difference is closer to the floor price than the first threshold difference, and
wherein losing bids below the second merchant-established threshold difference but above the first threshold difference are not eligible for the same price for the good, service, or discount on re-bid relative to the losing bids that are above the second merchant-established threshold.

20. Non-transitory computer usable medium comprising computer readable program code embedded therein, said computer readable program code adapted to be executed to:
use communications electronics to provide a plurality of user interfaces with information about the good, service, or discount;
receive, using the communications electronics, bids for the good, service, or discount from a plurality of user devices;
use processing electronics coupled to the communications electronics to collect the received bids and to determine winning bids and a losing bids by comparing the bids to a floor price; and
use the processing electronics to determine whether the losing bids qualify for re-bidding by comparing the losing bids to a first merchant-established threshold difference from the floor price.
